(19) United States
(12) Patent Application Publication
(10) Pub. No.: US 2025/0034310 A1
(43) Pub. Date: Jan. 30, 2025

(54) (CO)POLYMER-ACRYLIC BLOCK COPOLYMERS AND COATING COMPOSITIONS CONTAINING THE SAME

(71) Applicant: PPG Industries Ohio, Inc., Cleveland, OH (US)

(72) Inventors: Kareem Kaleem, Loveland, OH (US); Hanzhen Bao, Mason, OH (US); Michael Jonathan Motala, Cincinnati, OH (US); Youssef Moussa, Loveland, OH (US); Wenchao Zhang, Mason, OH (US); Carl Seneker, Milford, OH (US)

(73) Assignee: PPG Industries Ohio, Inc., Cleveland, OH (US)

(21) Appl. No.: 18/712,874

(22) PCT Filed: Nov. 21, 2022
(86) PCT No.: PCT/US2022/080207

§ 371 Date: May 23, 2024

Related U.S. Application Data
(60) Provisional application No. 63/365,289, filed on May 25, 2022.
(60) Provisional application No. 63/282,767, filed on Nov. 24, 2021.

(51) Int. Cl. C08F 290/06; C08F 220/06; C08F 220/08; C08F 220/14; C08F 220/18; C08F 220/20; C08G 63/91; C08K 5/3492; C09D 151/08

(52) U.S. Cl. CPC C08F 290/061; C08F 220/06; C08F 220/08; C08F 220/14; C08F 220/1802; C08F 220/20; C08G 63/916; C08G 63/918; C08K 5/34922; C09D 151/08

(57) ABSTRACT

A (co)polymer(A)-acrylic block copolymer obtainable by reacting reactants comprising an acrylic material with a (co)polymer(A) is disclosed. The (co)polymer(A) comprises a substantially terminal ethylenically unsaturated functional group. The acrylic material is reacted with the (co)polymer(A) so that the acrylic material bonds to the (co)polymer(A) via the substantially terminal ethylenically unsaturated functional group. The disclosure extends to a coating composition comprising the block copolymer; articles, such as a package, packaging, a vehicle, a structure, or parts thereof coated with the coating composition; and methods of making the same.

### FIELD

The present disclosure relates to a (co)polymer(A)-acrylic block copolymer and coating composition containing the same. The disclosure also relates to a package or packaging having a coating on at least a portion thereof, the coating being derived from the coating composition, and to methods of preparing the (co)polymer(A)-acrylic block copolymer, methods of preparing the coating composition and methods of coating a metal package or packaging.

### BACKGROUND

A wide variety of coatings have been used to coat food and/or beverage containers. The coating systems typically have certain properties such as being capable of high-speed application, having acceptable adhesion to the substrate, being safe for food contact and/or having properties that are suitable for their end use.

### SUMMARY

The present disclosure is directed to a (co)polymer(A)-acrylic block copolymer obtainable by reacting reactants comprising an acrylic material with a (co)polymer(A), wherein the (co)polymer(A) comprises a substantially terminal ethylenically unsaturated functional group, wherein the acrylic material is reacted with the (co)polymer(A) so that the acrylic material bonds to the (co)polymer(A) via the substantially terminal ethylenically unsaturated functional group.

The present disclosure is directed to a (co)polymer(A)-acrylic block copolymer obtainable by reacting reactants comprising an acrylic material with a (co)polymer(A), wherein the (co)polymer(A) comprises a substantially terminal ethylenically unsaturated functional group, wherein the acrylic material is reacted with the (co)polymer(A) so that the acrylic material bonds to the (co)polymer(A) via the substantially terminal ethylenically unsaturated functional group.

There is also provided a coating composition, the coating composition comprising:
a) a (co)polymer(A)-acrylic block copolymer, obtainable by reacting reactants comprising an acrylic material with a (co)polymer(A), wherein the (co)polymer(A) comprises a substantially terminal ethylenically unsaturated functional group, wherein the acrylic material is reacted with (co)polymer(A) so that the acrylic material bonds to the (co)polymer(A) via the substantially terminal ethylenically unsaturated functional group; and
b) a crosslinking material

There is also provided a package or packaging coated on at least a portion thereof with a coating, the coating being derived from a coating composition, the coating composition comprising:
a) a (co)polymer(A)-acrylic block copolymer, obtainable by reacting reactants comprising an acrylic material with a (co)polymer(A), wherein (co)polymer(A) comprises a substantially terminal ethylenically unsaturated functional group, wherein the acrylic material is reacted with (co)polymer(A) so that the acrylic material bonds to the (co)polymer(A) via the substantially terminal ethylenically unsaturated functional group; and
b) a crosslinking material.

There is also provided a method of forming a (co)polymer(A)-acrylic block copolymer, the method comprising reacting a substantially terminal hydroxyl-group or a substantially terminal carboxylic acid-group of a (co)polymer(A)-precursor with a material comprising an ethylenically unsaturated group or precursor thereof so as to form a (co)polymer(A) comprising a substantially terminal ethylenically unsaturated functional group, and then reacting an acrylic material with the (co)polymer(A) comprising a substantially terminal ethylenically unsaturated functional group so that the acrylic material bonds to the (co)polymer(A) via the substantially terminal ethylenically unsaturated functional group.

There is also provided a method of preparing a coating composition, the method comprising dispersing a (co)polymer(A)-acrylic block copolymer and a crosslinking material in a liquid carrier, the (co)polymer(A)-acrylic block copolymer being obtainable by reacting reactants comprising an acrylic material with a (co)polymer(A), wherein the (co)polymer(A) comprises a substantially terminal ethylenically unsaturated functional group, wherein the acrylic material is reacted with the (co)polymer(A) so that the acrylic material bonds to the (co)polymer(A) via the substantially terminal ethylenically unsaturated functional group.

There is also provided a method of coating at least a portion of a package or packaging, the method comprising applying a coating composition to a metal package or packaging composition, the coating composition comprising a (co)polymer(A)-acrylic block copolymer and a crosslinking material, the (co)polymer(A)-acrylic block copolymer being obtainable by reacting reactants comprising an acrylic material with a (co)polymer(A), wherein the (co)polymer(A) comprises a substantially terminal ethylenically unsaturated functional group, wherein the acrylic material is reacted with the (co)polymer(A) so that the acrylic material bonds to the (co)polymer(A) via the substantially terminal ethylenically unsaturated functional group, and curing the coating composition to form a coating.

### DETAILED DESCRIPTION

The copolymers of the present disclosure may be successfully dispersed in water to provide an aqueous coating composition having one or more desirable performance properties. For example, a coating formed from the coating composition of the present disclosure, such as a coating formed from a coating composition comprising a (co)polymer(A)-acrylic block copolymer obtainable from a (co)polymer(A)-precursor comprising a substantially terminal hydroxyl-group, may provide good pack performance, enamel rating and/or cure. It has been surprisingly found that the present coatings may provide an internal coating for use with a food and/or beverage that may have good hairing performance.

The coating compositions of the present disclosure, such as a coating composition comprising a (co)polymer(A)-acrylic block copolymer obtainable from ring-opening reaction, may provide improved cure and/or flexibility, while maintaining hard-to-hold performance. By “hard-to-hold” it is meant packaging contents that may be corrosive, and place higher resistance demands on the coating, such as requiring high acid resistance.

The coating compositions of the present disclosure, such as a coating composition comprising a (co)polymer(A)-acrylic block copolymer obtainable from ring-opening reaction, may provide improved heat aging performance with improved stability and/or storage performance.

By “heat aging” is meant exposure of a cured coating on a substrate exposed to 80 percent relative humidity at 100 degrees fahrenheit (38 degrees centigrade) for a period of 12 weeks.

By “(co)polymer(A)-acrylic block copolymer” herein it is meant a block (co)polymer in which an acrylic (co)polymer is bonded to a substantially terminal end of a (co)polymer(A). The block structure may be defined as A-Z-B, wherein A is a (co)polymer(A), B is an acrylic (co)polymer and Z is a residue formed from a substantially terminal ethylenically unsaturated functional group linking the (co)polymer(A) and acrylic (co)polymer.

It will be understood that the (co)polymer(A)-acrylic block copolymer may comprise graft bonding on the backbone of the (co)polymer(A), however any graft bonding on the (co)polymer(A) backbone will form a minority of the (co)polymer(A)-acrylic material bonds in the (co)polymer(A)-acrylic block copolymer, such as <30% of the bonds, or <20%, or <10%, and a majority of the (co)polymer(A)-acrylic material bonds will be in the form of acrylic (co)polymer bonded to a substantially terminal end of the (co)polymer(A), such as >60% of the bonds, or >80% or >90%. The (co)polymer(A)-acrylic block copolymer may be substantially free of acrylic material graft bonds on the backbone of the (co)polymer(A), such as <5% of the bonds, or <3%, or <2%.

The phrase ‘substantially terminal’ as used herein in relation to the hydroxyl, carboxylic acid and/or ethylenically unsaturated functional group may mean that the functional group is arranged on a monomer residue that is up to 5 monomer units, or up to 3 or up to 2 monomer units, or is adjacent to a terminal monomer unit in the backbone of (co)polymer(A), or may be a terminal monomer unit in the backbone of (co)polymer(A).

A terminal monomer unit in the backbone of (co)polymer(A) as used herein may be a monomer unit of the (co)polymer(A) that is at the end of the backbone chain of (co)polymer(A). A terminal monomer may comprise only one covalent bond joining the monomer to the polymer backbone. For example, a terminal monomer unit may comprise only one of the ‘bonding moieties’ of the (co)polymer backbone joining the terminal monomer with the backbone. The ‘bonding moiety’ of the (co)polymer(A) will depend on the (co)polymer used, e.g., for a polyester, the bonding moiety will be an ester moiety. As such, the term “terminal” as used herein, may mean that the monomer comprising the hydroxy, carboxylic acid or ethylenically unsaturated functional group is bonded to the (co)polymer backbone through a single bonding moiety.

The (co)polymer(A) comprising a substantially terminal ethylenically unsaturated functional group may be obtainable by reacting reactants comprising a substantially terminal hydroxyl-functional group or a substantially terminal carboxylic acid-functional group of a (co)polymer(A)-precursor with a material comprising an ethylenically unsaturated group or precursor thereof to form (co)polymer(A) comprising a substantially terminal ethylenically unsaturated functional group. The material may be operable to impart ethylenically unsaturated functionality to a substantially terminal end of the (co)polymer(A)-precursor.

The moiety formed at the bond between the (co)polymer(A)-precursor and the material comprising an ethylenically unsaturated group or precursor thereof may be a residue of a ring-opening reaction between the substantially terminal hydroxyl or carboxylic acid group and the material comprising an ethylenically unsaturated group or precursor thereof. The material comprising an ethylenically unsaturated group or precursor thereof may comprise a functional group having a ring that is operable to open upon reaction with the substantially terminal hydroxyl or carboxylic acid-group, such as an anhydride and/or epoxy functional group.

The moiety formed at the bond between the (co)polymer(A)-precursor and the material comprising an ethylenically unsaturated group or precursor thereof may be a hydroxy-ester moiety. When the (co)polymer(A)-precursor comprises a substantially terminal carboxylic acid-functional group, the moiety formed at the bond between the (co)polymer(A)-precursor and the material comprising an ethylenically unsaturated group or precursor thereof may be a hydroxy-ester moiety.

The carboxylic acid functional-group may be in the form of the acid, salt, anhydride, ester, or any other suitable derivative thereof. By “suitable derivative thereof” in relation to the carboxylic acid, it is meant a form of the carboxylic acid-functional group that is operable to be reacted with the material comprising an ethylenically unsaturated group or precursor thereof to form ethylenically unsaturated functionality to a substantially terminal end of the (co)polymer(A)-precursor.

The material comprising an ethylenically unsaturated group or precursor thereof may comprise a monomer, an oligomer and/or a (co)polymer, such as a monomer or an oligomer. The material comprising an ethylenically unsaturated group or precursor thereof may comprise a monomer. The material comprising an ethylenically unsaturated group or precursor thereof may comprise an anhydride, a vinyl monomer and/or an acrylic monomer.

As used herein, “precursor thereof” with respect to the ethylenically unsaturated group of the material comprising an ethylenically unsaturated group or precursor thereof may mean a group that is operable to form an ethylenically unsaturated group after the material comprising an ethylenically unsaturated group precursor has been reacted with a substantially terminal hydroxyl-group or a substantially terminal carboxylic acid-group of a (co)polymer(A)-precursor, wherein the ethylenically unsaturated group may be formed from the precursor group during the reaction with the (co)polymer(A)-precursor or subsequently.

The substantially terminal hydroxyl-group or substantially terminal carboxylic acid-group of a (co)polymer(A)-precursor may be reacted with a material comprising an ethylenically unsaturated group.

The material comprising an ethylenically unsaturated group or precursor thereof, such as for a (co)polymer(A)-acrylic block copolymer obtainable from a (co)polymer(A)-precursor comprising a substantially terminal hydroxyl-group, may comprise carboxylic acid and/or anhydride functionality, such as a carboxylic acid and/or anhydride functional acrylic monomer. The material comprising an ethylenically unsaturated group or precursor thereof, such as for a (co)polymer(A)-acrylic block copolymer obtainable from a (co)polymer(A)-precursor comprising a substantially terminal hydroxyl-group, may comprise: (meth)acrylic acid anhydride, tetrahydrophthalic anhydride, dodecenyl succinic anhydride, maleic anhydride, itaconic anhydride, citraconic anhydride, aconitic anhydride, oxalocitraconic anhydride, mesaconic anhydride, phenyl maleic anhydride, t-butyl maleic anhydride, nadic anhydride, and/or methyl maleic anhydride.

The material comprising an ethylenically unsaturated group or precursor thereof, such as for a (co)polymer(A)-acrylic block copolymer obtainable from a (co)polymer(A)-precursor comprising a substantially terminal hydroxyl-group, may comprise (meth)acrylic acid anhydride, tetrahydrophthalic anhydride, dodecenyl succinic anhydride, and/or maleic anhydride. The material comprising an ethylenically unsaturated group or precursor thereof, such as for a (co)polymer(A)-acrylic block copolymer obtainable from a (co)polymer(A)-precursor comprising a substantially terminal hydroxyl-group, may comprise (meth)acrylic acid anhydride, tetrahydrophthalic anhydride and/or dodecenyl succinic anhydride.

The material comprising an ethylenically unsaturated group or precursor thereof, such as for a (co)polymer(A)-acrylic block copolymer obtainable from a (co)polymer(A)-precursor comprising a substantially terminal carboxylic acid-group, may comprise epoxy functionality, such as a monoepoxide. The material comprising an ethylenically unsaturated group or precursor thereof, such as for a (co)polymer(A)-acrylic block copolymer obtainable from a (co)polymer(A)-precursor comprising a substantially terminal carboxylic acid-group, may comprise an epoxy functional acrylic monomer. The material comprising an ethylenically unsaturated group or precursor thereof, such as for a (co)polymer(A)-acrylic block copolymer obtainable from a (co)polymer(A)-precursor comprising a substantially terminal carboxylic acid-group, may comprise a glycidyl ester, such as glycidyl (meth)acrylate. The material comprising an ethylenically unsaturated group may comprise glycidyl methacrylate.

The material comprising an ethylenically unsaturated group or precursor thereof, such as for a (co)polymer(A)-acrylic block copolymer obtainable from a (co)polymer(A)-precursor comprising a substantially terminal carboxylic acid-group, may comprise hydroxyl functionality. The material comprising an ethylenically unsaturated group or precursor thereof, such as for a (co)polymer(A)-acrylic block copolymer obtainable from a (co)polymer(A)-precursor comprising a substantially terminal carboxylic acid-group, may comprise a hydroxyl functional acrylic monomer. The material comprising an ethylenically unsaturated group or precursor thereof, such as for a (co)polymer(A)-acrylic block copolymer obtainable from a (co)polymer(A)-precursor comprising a substantially terminal carboxylic acid-group, may comprise hydroxy ethyl (meth)acrylate.

The material comprising an ethylenically unsaturated group or precursor thereof may be present as a proportion of the total solid weight of the monomers used to form (co)polymer(A) in an amount of at least 0.01 wt. %, such as at least 0.5 wt %.

The material comprising an ethylenically unsaturated group or precursor thereof may be present as a proportion of the total solid weight of (co)polymer(A) in an amount of up to 10 wt. %, such as up to 5 wt %.

The material comprising an ethylenically unsaturated group or precursor thereof may be present as a proportion of the total solid weight of (co)polymer(A) in an amount of from 0.01 to 10 wt. %, such as from 0.5 to 5 wt %.

The material comprising an ethylenically unsaturated group or precursor thereof may have a molecular weight of ≥50 Daltons (Da=g/mole), such as ≥75 Da, such as ≥100 Da. The material comprising an ethylenically unsaturated group or precursor thereof may have a molecular weight of ≤750 Da, such as ≤500 Da, or ≤300 Da.

The material comprising an ethylenically unsaturated group or precursor thereof may have a molecular weight of from 50 Da to 750 Da, such as from 75 Da to 500 Da, such as from 100 Da to 300 Da.

As used herein, by “molecular weight” in relation to the material comprising an ethylenically unsaturated group or precursor thereof it is meant the molecular weight resulting from the sum of the atomic weights of the constituent atoms of a molecule of the material.

The (co)polymer(A) comprising a substantially terminal ethylenically unsaturated functional group may be obtainable by reacting reactants comprising a substantially terminal carboxylic acid or hydroxyl-functional group of a (co)polymer(A)-precursor with a material comprising an ethylenically unsaturated group or precursor thereof in the presence of a catalyst operable to promote the reaction of the material comprising an ethylenically unsaturated group or precursor thereof with the carboxylic acid or hydroxyl-functional group.

The catalyst, such as a catalyst for use with a substantially terminal hydroxyl-functional group may comprise an amine-based catalyst, such as a tertiary amine-based catalyst. The catalyst may comprise a cyclic tertiary amine-based catalyst, such as triethylenediamine.

The catalyst, such as a catalyst for use with a substantially terminal carboxylic acid-functional group may comprise a phosphonium-based catalyst, such as an aryl and alkyl substituted phosphonium-based catalyst, such as ethyl triphenyl phosphonium iodide.

The (co)polymer(A)/(co)polymer(A)-precursor may be a film former (co)polymer. By “film former” it is meant a compound that can form a self-supporting continuous coating film on at least a horizontal surface of a substrate.

The (co)polymer(A)/(co)polymer(A)-precursor may be a polyester (co)polymer, a polyurethane (co)polymer; a polyolefin (co)polymer, such as polybutadiene; and/or an epoxy (co)polymer, such as an epoxy (co)polymer that is substantially free of bisphenol A (BPA), bisphenol F (BPF), bisphenol A diglycidyl ether (BADGE), bisphenol F diglycidyl ether (BFDGE), and derivatives thereof.

“Substantially free” in relation to the epoxy (co)polymer refers to epoxy (co)polymers containing less than 1000 parts per million (ppm) of any of the compounds or derivatives thereof mentioned above. “Essentially free” refers to epoxy (co)polymers containing less than 100 ppm of any of the compounds or derivatives thereof mentioned above. By “completely free” refers to epoxy (co)polymers containing less than 20 parts per billion (ppb) of any of the compounds or derivatives thereof mentioned above.

The (co)polymer(A)/(co)polymer(A)-precursor may be a polyester (co)polymer. A polyester (co)polymer comprising a substantially terminal carboxylic acid or hydroxyl-functional group may be obtainable by polymerizing reactants comprising:
(i) a polyacid component, with
(ii) a polyol component.

The polyester (co)polymer may comprise a saturated polyester.

“Polyacid” and like terms as used herein, refers to a compound having two or more carboxylic acid groups, such as two (diacids), three (triacids) or four acid groups, and includes an ester of the polyacid (wherein an acid group is esterified) or an anhydride. The polyacid may be an organic polyacid.

The carboxylic acid groups of the polyacid may be connected by a bridging group selected from: an alkylene group; an alkenylene group; an alkynylene group; or an arylene group.

The polyester (co)polymer may be formed from any suitable polyacid. Examples of polyacids include, but are not limited to the following: maleic acid; fumaric acid; itaconic acid; adipic acid; azelaic acid; succinic acid; sebacic acid; glutaric acid; decanoic diacid; dodecanoic diacid; phthalic acid; isophthalic acid; 5-tert-butylisophthalic acid; tetrachlorophthalic acid; tetrahydrophthalic acid; trimellitic acid; naphthalene dicarboxylic acid; naphthalene tetracarboxylic acid; terephthalic acid; hexahydrophthalic acid; methylhexahydrophthalic acid; dimethyl terephthalate; cyclohexane dicarboxylic acid; chlorendic anhydride; 1,3-cyclohexane dicarboxylic acid; 1,4-cyclohexane dicarboxylic acid; tricyclodecane polycarboxylic acid; endomethylene tetrahydrophthalic acid; endoethylene hexahydrophthalic acid; cyclohexanetetra carboxylic acid; cyclobutane tetracarboxylic; a monomer having an aliphatic group containing at least 15 carbon atoms; esters and anhydrides of all the aforementioned acids and combinations thereof.

The polyacid component may comprise a diacid. Examples of diacids include, but are not limited to the following: phthalic acid; isophthalic acid; terephthalic acid; 1,4 cyclohexane dicarboxylic acid; succinic acid; adipic acid; azelaic acid; sebacic acid; fumaric acid; 2,6-naphthalene dicarboxylic acid; orthophthalic acid; phthalic anhydride; tetrahydrophthalic acid; hexahydrophthalic acid; maleic acid; succinic acid; itaconic acid; di-ester materials, such as dimethyl ester derivatives for example dimethyl isophthalate, dimethyl terephthalate, dimethyl 1,4-cyclohexane dicarboxylate, dimethyl 2,6-naphthalene di carboxylate, dimethyl fumarate, dimethyl orthophthalate, dimethylsuccinate, dimethyl glutarate, dimethyl adipate; a monomer having an aliphatic group containing at least 15 carbon atoms; esters and anhydrides of all the aforementioned acids; and mixtures thereof.

The polyacid component may comprise: terephthalic acid (TPA), dimethyl terephthalate, isophthalic acid (IPA), dimethyl isophthalic acid, 1,4 cyclohexane dicarboxylic acid, hexahydrophthalic anhydride, 2,6-naphthalene dicarboxylic acid, phthalic anhydride, maleic anhydride, fumaric anhydride; and/or a monomer having an aliphatic group containing at least 15 carbon atoms.

The polyacid component may comprise: terephthalic acid, isophthalic acid, dimethyl terephthalate, hexahydrophthalic anhydride, cyclohexane 1,4-dicarboxylic acid, maleic anhydride, and/or a monomer having an aliphatic group containing at least 15 carbon atoms.

The polyol component comprises a polyol. “Polyol” and like terms, as used herein, refers to a compound having two or more hydroxyl groups, such as two (diols), three (triols) or four hydroxyl groups (tetrols). The hydroxyl groups of the polyol may be connected by a bridging group selected from: an alkylene group; an alkenylene group; an alkynylene group; or an arylene group. The polyol may be an organic polyol.

The polyester (co)polymer may be formed from any suitable polyol. Examples of polyols include, but are not limited to the following: alkylene glycols, such as ethylene glycol; propylene glycol; diethylene glycol; dipropylene glycol; triethylene glycol; tripropylene glycol; hexylene glycol; polyethylene glycol; polypropylene glycol and neopentyl glycol; hydrogenated bisphenol A; cyclohexanediol; propanediols including 1,2-propanediol; 1,3-propanediol; butyl ethyl propanediol; 2-methyl-1,3-propanediol; and 2-ethyl-2-butyl-1,3-propanediol; butanediols including 1,4-butanediol; 1,3-butanediol; and 2-ethyl-1,4-butanediol; pentanediols including trimethyl pentanediol and 2-methylpentanediol; cyclohexanedimethanol; hexanediols including 1,6-hexanediol; 2,2,4,4-tetraalkylcyclobutane-1,3-diol (TACD), such as 2,2,4,4-tetramethylcyclobutane-1,3-diol (TMCD), 2,2,4-trimethyl-1,3-pentanediol (TMPD), butanediol, caprolactonediol (for example, the reaction product of a reaction mixture comprising epsilon-capro lactone and ethylene glycol); hydroxyalkylated bisphenols; polyether glycols, for example, poly(oxytetramethylene) glycol; trimethylol propane; pentaerythritol; di-pentaerythritol; trimethylol ethane; trimethylol butane; dimethylol cyclohexane; bio-derived polyols such as glycerol, sorbitol and isosorbide; a monomer having an aliphatic group containing at least 15 carbon atoms; and the like or combinations thereof.

The diols may be selected from: ethylene glycol; 1,2-propane diol; 1,3-propane diol; 1,2-butandiol; 1,3-butandiol; 1,4-butandiol; but-2-ene 1,4-diol; 2,3-butane diol; 2-methyl 1,3-propane diol; 2,2′-dimethyl 1,3-propanediol (neopentyl glycol); 1,5 pentane diol; 3-methyl 1,5-pentanediol; 2,4-diethyl 1,5-pentane diol; 1,6-hexane diol; 2-ethyl 1,3-hexane diol; 2,2,4,4-tetraalkylcyclobutane-1,3-diol (TACD), such as 2,2,4,4-tetramethylcyclobutane-1,3-diol (TMCD), 2,2,4-trimethyl-1,3-pentanediol (TMPD), diethylene glycol; triethylene glycol; dipropylene glycol; tripropylene glycol; 1,4 cyclohexane dimethanol; tricyclodecane dimethanol; isosorbide; butanediol, 1,4-cyclohexane diol; and/or 1,1′-isopropylidene-bis (4-cyclohexanol); and mixtures thereof.

The polyol component may comprise a polyol having at least three hydroxyl groups, such as trimethylol propane; pentaerythritol; di-pentaerythritol; trimethylol ethane; trimethylol butane; and/or bio-derived polyols such as glycerol and/or sorbitol. The polyol component having at least three hydroxyl groups may comprise a triol or tetrol, such as trimethylol propane; pentaerythritol; trimethylol ethane; trimethylol butane and/or glycerol. The polyol component having at least three hydroxyl groups may comprise a triol, such as trimethylol propane; trimethylol ethane; and/or trimethylol butane, for example trimethylol propane.

The polyol having at least three hydroxyl groups may be present as a proportion of the solid weight of the polyol component in an amount of ≥0.1 wt %, such as ≥0.5 wt % or ≥0.7 wt %, for example ≥0.8 wt % or ≥0.9 wt %, such as ≥1 wt %.

The polyol having at least three hydroxyl groups may be present as a proportion of the solid weight of the polyol component in an amount of ≤10 wt %, such as ≤8 wt % or ≤6 wt %, for example ≤5 wt % or ≤4 wt %, such as ≤3 wt % or ≤2 wt %.

The polyol having at least three hydroxyl groups may be present as a proportion of the solid weight of the polyol component in an amount of from 0.1 to 10 wt %, such as from 0.5 to 8 wt % or from 0.7 to 6 wt %, for example from 0.8 to 5 wt % or from 0.9 to 4 wt %, such as from 1 to 3 wt % or from 1 to 2 wt %.

The polyacid and/or polyol may comprise a polyacid/polyol comprising a tricyclic moiety, such as a bridged tricyclic moiety. The polyacid and/or polyol may comprise a tricyclodecane moiety. The polyol may comprise tricyclodecanedimethanol.

The molar ratio of polyol: polyacid, such as for a (co)polymer(A)-precursor comprising a substantially terminal hydroxyl-group, may be >1:1. The polyester (co)polymer may be formed from polyol and polyacid, wherein the polyol is in excess of the polyacid.

The molar ratio of polyacid: polyol, such as for a (co)polymer(A)-precursor comprising a substantially terminal carboxylic acid-group, may be >1:1. The polyester (co)polymer may be formed from polyol and polyacid, wherein the polyacid is in excess of the polyol.

The polyol component may comprise ethylene glycol (EG), 1,2-propylene glycol (PG), 2-methyl propanediol (2-MPD), neopentyl glycol (NPG), 1,4-cyclohexane dimethanol (CHDM), butyl ethyl propane diol (BEPD), trimethylolpropane (TMP), tricyclodecane dimethanol, butanediol and/or 1,6 hexanediol.

Further details of such a monomer having an aliphatic group containing at least 15 carbon atoms are disclosed in published PCT patent application WO 2018/111854, specifically,

paragraphs to inclusive. The entire contents of WO 2018/111854 and specifically paragraphs to inclusive thereof are fully incorporated herein by reference.

The (co)polymer(A)/(co)polymer(A)-precursor and/or the (co)polymer(A)-acrylic block copolymer may have a number average molecular weight (Mn) of ≥2,000 Da, such as ≥4,000 Da, or ≥5,000 Da. The (co)polymer(A)/(co)polymer(A)-precursor and/or the (co)polymer(A)-acrylic block copolymer may have a number average molecular weight (Mn) of ≤30,000 Da, such as ≤25,000 Da, such as ≤20,000 Da, or ≤18,000 Da.

The (co)polymer(A)/(co)polymer(A)-precursor comprising a substantially terminal hydroxyl-functional group and/or the (co)polymer(A)-acrylic block copolymer formed from such a (co)polymer(A)/precursor may have a number average molecular weight (Mn) of ≥3,000 Da, such as ≥5,000 Da, or ≥8,000 Da. The (co)polymer(A)/(co)polymer(A)-precursor comprising a substantially terminal hydroxyl-functional group and/or the (co)polymer(A)-acrylic block copolymer formed from such a (co)polymer(A)/precursor may have a number average molecular weight (Mn) of ≤30,000 Da, such as ≤25,000 Da, such as ≤20,000 Da, or ≤18,000 Da.

The (co)polymer(A)/(co)polymer(A)-precursor comprising a substantially terminal carboxylic acid-functional group and/or the (co)polymer(A)-acrylic block copolymer formed from such a (co)polymer(A)/precursor may have a number average molecular weight (Mn) of ≥2,000 Da, such as ≥4,000 Da, or ≥5,000 Da. The (co)polymer(A)/(co)polymer(A)-precursor comprising a substantially terminal carboxylic acid-functional group and/or the (co)polymer(A)-acrylic block copolymer formed from such a (co)polymer(A)/precursor may have a number average molecular weight (Mn) of ≤20,000 Da, such as ≤15,000 Da, such as ≤10,000 Da.

The (co)polymer(A)/(co)polymer(A)-precursor and/or the (co)polymer(A)-acrylic block copolymer may have a Mn from 2,000 Daltons (Da=g/mole) to 30,000 Da, such as from 4,000 Da to 25,000 Da, such as from 5,000 Da to 22,000 Da.

The (co)polymer(A)/(co)polymer(A)-precursor comprising a substantially terminal hydroxyl-functional group and/or the (co)polymer(A)-acrylic block copolymer formed from such a (co)polymer(A)/precursor may have a Mn from 3,000 Daltons (Da=g/mole) to 30,000 Da, or from 5,000 Da to 30,000 Da, such as from 7,000 Da to 25,000 Da, or from 8,000 Da to 25,000 Da, such as from 10,000 Da to 22,000 Da, or even from 13,000 to 20,000 Da.

The (co)polymer(A)/(co)polymer(A)-precursor comprising a substantially terminal carboxylic acid-functional group and/or the (co)polymer(A)-acrylic block copolymer formed from such a (co)polymer(A)/precursor may have a Mn of from 2,000 Daltons (Da=g/mole) to 20,000 Da, or from 4,000 Daltons (Da=g/mole) to 15,000 Da, such as from 5,000 Da to 10,000 Da.

As reported herein, the Mn was determined by gel permeation chromatography using a polystyrene standard according to ASTM D6579-11 (“Standard Practice for Molecular Weight Averages and Molecular Weight Distribution of Hydrocarbon, Rosin and Terpene Resins by Size Exclusion Chromatography”. UV detector; 254 nm, solvent: unstabilised THF, retention time marker: toluene, sample concentration: 2 mg/ml).

The (co)polymer(A)/(co)polymer(A)-precursor may have any suitable glass transition temperature (Tg). The (co)polymer(A)/(co)polymer(A)-precursor and/or the (co)polymer(A)-acrylic block copolymer may have a Tg of ≥20° C., such as ≥30° C., or ≥40° C. The (co)polymer(A)/(co)polymer(A)-precursor and/or the (co)polymer(A)-acrylic block copolymer may have a Tg of ≤115° C., such as ≤105° C., or ≤95° C. The (co)polymer(A)/(co)polymer(A)-precursor and/or the (co)polymer(A)-acrylic block copolymer may have a glass transition temperature (Tg) of from 20° C. to 115° C., such as from 30° C. to 105° C., such as from 40° C. to 95° C.

As reported herein, the Tg was measured according to ASTM D6604-00 (2013) (“Standard Practice for Glass Transition Temperatures of Hydrocarbon Resins by Differential Scanning calorimetry”. Heat-flux differential scanning calorimetry (DSC), sample pans: aluminium, reference: blank, calibration: indium and mercury, sample weight: 10 mg, heating rate: 20° C./min).

The (co)polymer(A)/(co)polymer(A)-precursor and/or the (co)polymer(A)-acrylic block copolymer and/or a coating formed from the coating composition may have any suitable gross hydroxyl value (OHV). The (co)polymer(A)/(co)polymer(A)-precursor and/or the (co)polymer(A)-acrylic block copolymer and/or a coating formed from the coating composition may have a gross OHV of from 0 to 120 mg KOH/g, such as from 5 to 100 mg KOH/g, such as from 5 to 80 mg KOH/g, or from 5 to 50 mg KOH/g, or from 7 to 40 mg KOH/g, such as from 10 to 30 mg KOH/g or 10 to 20 mg KOH/g.

The gross OHV of the (co)polymer(A)/(co)polymer(A)-precursor may be lower than the gross OHV of the (co)polymer(A)-acrylic block copolymer.

The (co)polymer(A)/(co)polymer(A)-precursor may have a gross OHV of from 5 to 50 mg KOH/g, or from 5 to 30 mg KOH/g, such as from 5 to 20 mg KOH/g.

The (co)polymer(A)-acrylic block copolymer may have a gross OHV of from 5 to 100 mg KOH/g, such as from 5 to 80 mg KOH/g, or from 5 to 50 mg KOH/g, such as from 5 to 40 mg KOH/g.

The gross OHV is expressed on solids.

As reported herein, the hydroxyl value is the number of mg of KOH equivalent to the hydroxyl groups in 1 g of material. A sample of solid polyester (0.13 g) was weighed accurately into a conical flask and dissolved, using light heating and stirring as appropriate, in 20 ml of tetrahydrofuran. 10 ml of 0.1M 4-(dimethylamino) pyridine in tetrahydrofuran (catalyst solution) and 5 ml of a 9 vol % solution of acetic anhydride in tetrahydrofuran (i.e. 90 ml acetic anhydride in 910 ml tetrahydrofuran; acetylating solution) were then added to the mixture. After 5 minutes, 10 ml of an 80 vol % solution of tetrahydrofuran (i.e. 4 volume parts tetrahydrofuran to 1 part distilled water; hydrolysis solution) was added. After 15 minutes, 10 ml tetrahydrofuran was added and the solution was titrated with 0.5M ethanolic potassium hydroxide (KOH). A blank sample was also run where the sample of solid polyester was omitted. The resulting hydroxyl number is expressed in units of mg KOH/g and is calculated using the following equation:

$$Hydroxyl value = \frac{( {V}_{2} - {V}_{1} ) \times molarity of KOH solution ( M ) \times 56.1}{weight of solid sample ( g )}$$

wherein V₁ is the titre of KOH solution (ml) of the polyester sample and V₂ is the titre of KOH solution (ml) of the blank sample. All values for gross hydroxyl value reported herein were measured in this way.

The (co)polymer(A)/(co)polymer(A)-precursor may have any suitable acid value (AV).

The (co)polymer(A)/(co)polymer(A)-precursor, such as a (co)polymer(A) obtainable from a (co)polymer(A)-precursor comprising a substantially terminal hydroxyl-group or a (co)polymer(A)-precursor comprising a substantially terminal hydroxyl-group, may have an AV of up to 20 mg KOH/g, such as up to 10 mg KOH/g, or up to 5 mg KOH/g or even up to 3 mg KOH/g.

The (co)polymer(A)-precursor, such as a (co)polymer(A)-precursor comprising a substantially terminal carboxylic acid-group, may have an AV of at least 1 KOH/g, such as at least 3 KOH/g or at least 5 KOH/g.

The (co)polymer(A)-precursor, such as a (co)polymer(A)-precursor comprising a substantially terminal carboxylic acid-group, may have an AV of up to 40 KOH/g, such as up to 30 KOH/g or up to 20 KOH/g.

The (co)polymer(A)-precursor, such as a (co)polymer(A)-precursor comprising a substantially terminal carboxylic acid-group, may have an AV of from 1 to 40 KOH/g, such as from 3 to 30 KOH/g, such as from 5 to 20 KOH/g.

The (co)polymer(A), such as a (co)polymer(A) obtainable from a (co)polymer(A)-precursor comprising a substantially terminal carboxylic acid-group, may have an AV of up to 5 KOH/g, such as up to 2 KOH/g or up to 1 KOH/g.

The acid value of (co)polymer(A) may be lower than the acid value of the (co)polymer(A)-precursor.

The (co)polymer(A)-acrylic block copolymer may have an AV of at least 5 KOH/g, such as at least 8 KOH/g or at least 10 KOH/g.

The (co)polymer(A)-acrylic block copolymer may have an AV of up to 100 KOH/g, such as up to 80 KOH/g or up to 70 KOH/g.

The (co)polymer(A)-acrylic block copolymer may have an AV of from 5 to 100 KOH/g, such as from 8 to 80 KOH/g, such as from 10 to 70 KOH/g.

The acid value of (co)polymer(A) may be lower than the acid value of the (co)polymer(A)-acrylic block copolymer.

The AV is expressed on solids.

As reported herein, the AV was determined by titration with 0.1M methanolic potassium hydroxide (KOH) solution. A sample of solid polyester (0.1 g) was weighed accurately into a conical flask and dissolved, using light heating and stirring as appropriate, in 25 ml of dimethyl formamide containing phenolphthalein indicator. The solution was then cooled to room temperature and titrated with the 0.1M methanolic potassium hydroxide solution. The resulting acid number is expressed in units of mg KOH/g and is calculated using the following equation:

$$Acid number = titre of KOH solution ( ml ) \times molarity KOH solution ( M ) \times 56.1$$

$$weight of solid sample ( g )$$

All values for acid number reported herein were measured in this way.

The (co)polymer(A)/(co)polymer(A)-precursor, such as a (co)polymer(A) obtainable from a (co)polymer(A)-precursor comprising a substantially terminal hydroxyl-group or a (co)polymer(A)-precursor comprising a substantially terminal hydroxyl-group, may have a Mn of ≥3,000 Da, a gross OHV of from 5 to 50 mg KOH/g and an acid value of from 0 to 10 mg KOH/g. The (co)polymer(A)/(co)polymer(A)-precursor may have a Mn of ≥5,000 Da, a gross OHV of from 10 to 20 mg KOH/g and an acid value of less than 5 mg KOH/g, such as less than 3 mg KOH/g or less than 1 mg KOH/g.

The (co)polymer(A)-precursor, such as a (co)polymer(A)-precursor comprising a substantially terminal carboxylic-group, may have a Mn of ≥2,000 Da, a gross OHV of from 5 to 50 mg KOH/g and an acid value of at least 1 KOH/g. The (co)polymer(A)-precursor may have a Mn of >4,000 Da, a gross OHV of from 5 to 30 mg KOH/g and an acid value of at least 3 KOH/g.

The (co)polymer(A), such as a (co)polymer(A) obtainable from a (co)polymer(A)-precursor comprising a substantially terminal carboxylic-group, may have a Mn of ≥2,000 Da, a gross OHV of from 5 to 50 mg KOH/g and an acid value of up to 1 KOH/g. The (co)polymer(A) may have a Mn of ≥4,000 Da, a gross OHV of from 5 to 30 mg KOH/g and an acid value of up to 1 KOH/g.

The (co)polymer(A) may be obtainable by reacting a (co)polymer(A)-precursor comprising a substantially terminal hydroxyl functional group with a material comprising an ethylenically unsaturated group or precursor thereof and with a material operable to reduce the acid value of the (co)polymer(A). The (co)polymer(A)-precursor may be reacted with the material operable to reduce the acid value of the (co)polymer(A) following reaction with the material comprising an ethylenically unsaturated group or precursor thereof. The material operable to reduce the acid value of the (co)polymer(A) may be as defined herein for the material comprising an ethylenically unsaturated group or precursor thereof.

The material operable to reduce the acid value of the (co)polymer(A) may comprise epoxy and/or hydroxyl functionality, such as a monoepoxide. The material operable to reduce the acid value of the (co)polymer(A) may comprise glycidol.

The material operable to reduce the acid value of the (co)polymer(A) may comprise a small molecule compound. A small molecule material operable to reduce the acid value of the (co)polymer(A) may have a molecular weight of <750 Da, such as ≤600 Da or ≤500 Da.

The acrylic material may be an acrylic (co)polymer or be formed from acrylic monomers. The acrylic material may be formed from acrylic monomers. The acrylic material may be polymerized onto the polyester resin by polymerizing acrylic monomers in the presence of the (co)polymer(A) comprising a substantially terminal ethylenically unsaturated functional group to form the (co)polymer(A)-acrylic block copolymer. The bonding of acrylic material onto the substantially terminal end of the (co)polymer(A) may occur via free radical polymerization, such as by free radical polymerization with the substantially terminal ethylenic unsaturation of the (co)polymer(A).

Various acrylic monomers can be combined to prepare the acrylic material. Examples include methyl(meth)acrylate, ethyl(meth)acrylate, butyl(meth)acrylate, cyclohexyl (meth) acrylate; allyl (meth)acrylate; isobornyl (meth)acrylate, hydroxyethyl (meth)acrylate, 2-ethylhexyl (meth)acrylate, (meth)acrylic acid, dimethylamino ethyl methacrylate, butylamino ethyl (meth)acrylate, and/or HEMA phosphate (such as ethylene glycol methacrylate phosphate). Any other acrylic monomers known to those skilled in the art could also be used.

The term “(meth)acrylate” and like terms are used conventionally and herein to refer to both methacrylate and acrylate.

The acrylic material may comprise methyl (meth)acrylate, ethyl (meth)acrylate, butyl (meth)acrylate, hydroxyethyl (meth)acrylate, (meth)acrylic acid, cyclohexyl (meth)acrylate, allyl (meth)acrylate, dimethylamino ethyl methacrylate, butylamino ethyl (meth)acrylate, and/or HEMA phosphate (such as ethylene glycol methacrylate phosphate).

The acrylic material may comprise: (meth)acrylic acid, ethyl (meth)acrylate, methyl (meth)acrylate, hydroxyethyl (meth)acrylate, propyl (meth)acrylate, butyl (meth)acrylate, and/or styrene,

The acrylic material, such as for a (co)polymer(A)-acrylic block copolymer obtainable from a (co)polymer(A)-precursor comprising a substantially terminal hydroxyl-group, may comprise methacrylic acid, ethyl methacrylate, methyl methacrylate, and/or hydroxyethyl methacrylate.

The acrylic monomers, such as for a (co)polymer(A)-acrylic block copolymer obtainable from a (co)polymer(A)-precursor comprising a substantially terminal hydroxyl-group, may comprise a ratio of methacrylate monomers to acrylate monomers of at least 1:1, such as at least 2:1 or at least 3:1 or at least 4:1, such as at least 5:1. The acrylic monomers may be substantially free of acrylate monomers. As used herein, “substantially free” in relation to the content of acrylate monomers means that the acrylic monomers comprise ≤5% acrylate monomers by total weight of the acrylic monomers. By “methacrylate monomers” and “acrylate monomers” with regard to the ratio of these types of monomers in the acrylic monomers of the acrylic material, it is meant the total number of methacrylate monomers compared to the total number of acrylate monomers across all the types of acrylic monomer that form the acrylic material. For example, if the acrylic material is formed of methylmethacrylate, methyl acrylate and butyl acrylate, then the amount of methylmethacrylate compared to the combined amount of methyl acrylate and butyl acrylate would be at least 5:1.

The acrylic monomers may comprise a hydroxyl functional monomer, such as hydroxyethyl (meth)acrylate. The hydroxyl functional monomer may be present by solid weight of the acrylic material in an amount of ≥5 wt % or ≥10 wt %.

The hydroxyl functional monomer may be present by solid weight of the acrylic material in an amount of ≤90 wt %, such as ≤80 wt % or ≤70 wt %.

The hydroxyl functional monomer may be present by solid weight of the acrylic material in an amount of from >0 to 90 wt %, such as from 5 to 80 wt % or from 10 to 70 wt %.

The hydroxyl functional monomer may be present by solid weight of the acrylic material in an amount of ≤50 wt %, such as ≤40 wt % or ≤30 wt %.

The hydroxyl functional monomer may be present by solid weight of the acrylic material in an amount of from >0 to 50 wt %, such as from 5 to 40 wt % or from 10 to 30 wt %.

The acrylic material may also comprise an amount (such as 0 to 30 wt %, by solid weight of the acrylic (co)polymer) of non-acrylic monomers. Such non acrylic monomers may include other ethylenically unsaturated monomers, such as styrene, ethylene, propylene, vinyl toluene, butadiene, 1-octene or isoprene, vinyl esters such as vinyl acetate; an acrylamide, such as an acrylamide monomer of formula I, such as N-butoxymethyl acrylamide; and/or a nitrile such as (meth)acrylonitrile. The acrylic material may also comprise styrene and/or an acrylamide monomer of formula I, such as N-butoxymethyl acrylamide.

The acrylic material may comprise an acrylamide monomer of formula I:

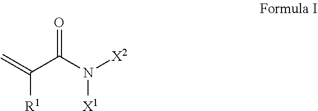

wherein R¹ represents a H or alkyl group; and
X¹ represents a linear or branched alkyl, a —Y—O—Z group; or is according to formula II;

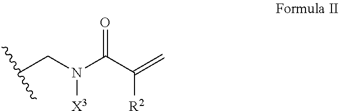

wherein
   Y represents a bivalent linear or branched alkylene bridging group, and
   Z represents linear or branched alkyl group, or is according to formula II, or H;
   X³ represents a H or alkyl group;
   R² represents a H or alkyl group;
X² represents a linear or branched alkyl, H or a —Y—O—Z group;
wherein
   Y represents a bivalent linear or branched alkylene bridging group, and Z represents a linear or branched alkyl group, or H.
X¹ may represent a linear or branched alkyl, or a —Y—O—Z group.
X¹ may represent a linear or branched alkyl, or a —Y—O—Z group, and Z may represent a linear or branched alkyl group, or H.
R¹ may represent H or C₁-C₂₀ alkyl group, such as C₁-C₁₀ alkyl group, such as C₁-C₈ alkyl group, such as C₁-C₆ alkyl group, such as C₁-C₄ alkyl group. R¹ may represent H, methyl, ethyl, n-propyl, i-propyl, n-butyl, t-butyl, pentyl, hexyl, heptyl, octyl, nonyl, decyl, cyclohexyl or cycloheptyl group. R¹ may represent H or C₁-C₄ alkyl group, such as methyl, ethyl, propyl or butyl group. R¹ may represent H.
R² may represent H or C₁-C₂₀ alkyl group, such as C₁-C₁₀ alkyl group, such as C₁-C₈ alkyl group, such as C₁-C₆ alkyl group, such as C₁-C₄ alkyl group. R² may represent H, methyl, ethyl, n-propyl, i-propyl, n-butyl, t-butyl, pentyl, hexyl, heptyl, octyl, nonyl, decyl, cyclohexyl or cycloheptyl group. R² may represent H or C₁-C₄ alkyl group, such as methyl, ethyl, propyl or butyl group. R² may represent H.
X¹ may represent a linear or branched C₁-C₂₀ alkyl group, such as C₁-C₁₀ alkyl group, such as C₁ to C₈ alkyl group, such as C₁-C₆ alkyl group, such as C₁-C₄ alkyl group. X¹ may represent methyl, ethyl, n-propyl, i-propyl, n-butyl, t-butyl, pentyl, hexyl, heptyl, octyl, nonyl, decyl, cyclohexyl or cycloheptyl group. X¹ may represent a C₁-C₄ alkyl group, such as methyl, ethyl, propyl or butyl group. X¹ may represent —Y—O—Z group.
X² may represent a linear or branched C₁-C₂₀ alkyl group, such as C₁-C₁₀ alkyl group, such as C₁ to C₈ alkyl group, such as C₁-C₆ alkyl group, such as C₁-C₄ alkyl group, or H. X² may represent H, methyl, ethyl, n-propyl, i-propyl, n-butyl, t-butyl, pentyl, hexyl, heptyl, octyl, nonyl, decyl, cyclohexyl or cycloheptyl group. X² may represent H or C₁-C₄ alkyl group, such as methyl, ethyl, propyl or butyl group. X² may represent a —Y—O—Z group. X² may represent H.
X³ may represent a linear or branched C₁-C₂₀ alkyl group, such as C₁-C₁₀ alkyl group, such as C₁ to C₈ alkyl group, such as C₁-C₆ alkyl group, such as C₁-C₄ alkyl group, or H. X³ may represent H, methyl, ethyl, n-propyl, i-propyl, n-butyl, t-butyl, pentyl, hexyl, heptyl, octyl, nonyl, decyl, cyclohexyl or cycloheptyl group. X³ may represent a H or C₁-C₄ alkyl group, such as methyl, ethyl, propyl or butyl group. X³ may represent H.
Y may represent a bivalent linear or branched alkylene bridging group, such as C₁-C₁₀ alkylene bridging group, such as C₁-C₈ alkylene bridging group, such as C₁-C₆ alkylene bridging group, such as C₁-C₄ alkylene bridging group. Y may represent methylene, ethylene, propylene, butylene, pentylene, hexylene, heptylene, octylene, nonylene or decylene. Y may represent a methylene, ethylene or propylene group.
Z may represent a linear or branched C₁-C₂₀ alkyl group, such as C₁-C₁₀ alkyl group, such as C₁ to C₈ alkyl group, such as C₂-C₇ alkyl group, such as C₂-C₆ alkyl group, or H. Z may represent H, methyl, ethyl, n-propyl, i-propyl, n-butyl, t-butyl, pentyl, hexyl, heptyl, octyl, nonyl, decyl, cyclohexyl or cycloheptyl group. Z may represent H or C₂-C₆ alkyl group, such as, ethyl, propyl, butyl group, pentyl or hexyl.
R¹, X¹ and X² may each be selected independently from the above lists to for any combination of an acrylamide of formula I according to the disclosure. For example, both X¹ and X² may each independently be selected as the same, or different-Y—O—Z groups. At least two of R¹, X¹ or X² may be the same. At least X¹ and X² may be different groups.
X¹ and X² may be covalently linked such as to form a cyclic structure.

The acrylic material may comprise an acrylamide monomer of formula I wherein R¹ represents H or C₁-C₄ alkyl group; X¹ represents a C₁-C₁₀ alkyl group or a —Y—O—Z group wherein Y represents a C₁-C₈ alkylene bridging group and Z represents a C₁-C₁₀ alkyl group; and X² represents H or C₁-C₄ alkyl group.

The acrylic material may comprise an acrylamide monomer of formula I wherein R¹ represents H or C₁-C₄ alkyl group; X¹ represents a —Y—O—Z group wherein Y represents a C₁-C₄ alkylene bridging group and Z represents a C₂-C₇ alkyl group; and X² represents H.

The acrylic material may comprise an acrylamide monomer of formula I wherein R¹ represents H or methyl; X¹ represents a —Y—O—Z group wherein Y represents a methylene or ethylene bridging group and Z represents a C₂-C₆ alkyl group; and X² represents H.

The acrylic material may comprise a monomer component comprising n-butoxymethyl acrylamide (NBMA).

An acrylamide monomer according to formula I may be present by solid weight of the acrylic material in an amount of ≥5 wt %, such as ≥8 wt % or ≥10 wt %.

An acrylamide monomer according to formula I may be present by solid weight of the acrylic material in an amount of ≤60 wt %, such as ≤40 wt % or ≤30 wt %.

An acrylamide monomer according to formula I be present by solid weight of the acrylic material in an amount of from 5 to 60 wt %, such as from 8 to 40 wt % or from 10 to 30 wt %.

The acrylic material, such as for a (co)polymer(A)-acrylic block copolymer obtainable from a (co)polymer(A)-precursor comprising a substantially terminal carboxylic acid-group, may comprise methacrylic acid, styrene, ethyl acrylate, N-butoxymethyl acrylamide and/or hydroxyethyl methacrylate.

The acrylic material may comprise acid functionality, which may be at least partially neutralised with a neutralisation agent.

The acrylic monomers may comprise an acid functional monomer, such as (meth)acrylic acid. The acid functional monomer may be present by solid weight of the acrylic material in an amount of ≥5 wt %, such as ≥10 wt % or ≥20 wt %.

The acid functional monomer may be present by solid weight of the acrylic material in an amount of ≤90 wt %, such as ≤80 wt % or ≤70 wt %.

The acid functional monomer may be present by solid weight of the acrylic material in an amount of from 5 to 90 wt %, such as from 10 to 80 wt % or from 20 to 70 wt %.

The neutralisation agent may comprise ammonia or amine functional moieties: methyl ethanolamine, dimethylethanolamine (DMEA), trimethylamine, diethylene triamine.

The acid functionality may be at least 5% neutralised with a neutralisation agent. The acid functionality may be at least 25% neutralised with a neutralisation agent. The acid functionality may be at least 50% neutralised with a neutralisation agent. The acid functionality may be at least 75% neutralised with a neutralisation agent.

The (co)polymer(A)-acrylic block copolymer, such as a (co)polymer(A)-acrylic block copolymer obtainable from a (co)polymer(A)-precursor comprising a substantially terminal hydroxyl-group, may comprise ≤30 wt % of acrylic material based on the total solid weight of the (co)polymer(A)-acrylic block copolymer, such as ≤25 wt %, or even ≤20 wt %.

The (co)polymer(A)-acrylic block copolymer, such a (co)polymer(A)-acrylic block copolymer obtainable from a (co)polymer(A)-precursor comprising a substantially terminal hydroxyl-group, may comprise >5 wt % of acrylic material based on the total solid weight of the (co)polymer(A)-acrylic block copolymer, such as ≥10 wt %, or even ≥15 wt %.

The (co)polymer(A)-acrylic block copolymer, such as a (co)polymer(A)-acrylic block copolymer obtainable from a (co)polymer(A)-precursor comprising a substantially terminal hydroxyl-group, may be formed from the (co)polymer(A) and an acrylic material in a weight ratio of from 95 wt % to 70 wt % (co)polymer(A) to from 30 wt % to 5 wt % acrylic material, such as from 90 wt % to 70 wt % (co)polymer(A) to from 30 wt % to 10 wt % acrylic material, or from 95 wt % to 70 wt % (co)polymer(A) to from 30 wt % to 5 wt % acrylic material, such as a weight ratio of from 95 wt % to 75 wt % (co)polymer(A) to from 25 wt % to 5 wt % acrylic material, such as a weight ratio of from 90 wt % to 75 wt % (co)polymer(A) to from 25 wt % to 10 wt % acrylic material.

The (co)polymer(A)-acrylic block copolymer, such as a (co)polymer(A)-acrylic block copolymer obtainable from a (co)polymer(A)-precursor comprising a substantially terminal carboxylic acid-group and/or for spray application, may comprise ≤50 wt % of acrylic material based on the total solid weight of the (co)polymer(A)-acrylic block copolymer, such as ≤40 wt %, or even ≤35 wt %.

The (co)polymer(A)-acrylic block copolymer, such as a (co)polymer(A)-acrylic block copolymer obtainable from a (co)polymer(A)-precursor comprising a substantially terminal carboxylic acid-group and/or for spray application, may comprise ≥10 wt % of acrylic material based on the total solid weight of the (co)polymer(A)-acrylic block copolymer, such as ≥15 wt %, or even ≥20 wt %.

The (co)polymer(A)-acrylic block copolymer, such as a (co)polymer(A)-acrylic block copolymer obtainable from a (co)polymer(A)-precursor comprising a substantially terminal carboxylic acid-group and/or for spray application, may be formed from the (co)polymer(A) and an acrylic material in a weight ratio of from 90 wt % to 50 wt % (co)polymer(A) to from 50 wt % to 10 wt % acrylic material, such as from 85 wt % to 60 wt % (co)polymer(A) to from 40 wt % to 15 wt % acrylic material, or from 80 wt % to 65 wt % (co)polymer(A) to from 35 wt % to 20 wt % acrylic material.

The (co)polymer(A)/(co)polymer(A)-precursor may be prepared in the presence of an esterification catalyst. The esterification catalyst may be chosen to promote the reaction of components by esterification and/or trans-esterification. The esterification catalysts, such as for use in the preparation of a polyester (co)polymer, may comprise: metal compounds such as stannous octoate; stannous chloride; butyl stannoic acid (hydroxy butyl tin oxide); monobutyl tin tris (2-ethylhexanoate); chloro butyl tin dihydroxide; dibutyl tin oxide; tetra-n-propyl titanate; tetra-n-butyl titanate; zinc acetate; acid compounds such as phosphoric acid; para-toluene sulphonic acid; dodecyl benzene sulphonic acid (DDBSA), tetra alkyl zirconium materials, antimony trioxide, germanium dioxide, bismuth octoate and combinations thereof. The esterification catalyst may comprise dodecyl benzene sulphonic acid (DDBSA). The esterification catalyst may comprise dibutyl tin oxide or stannous octoate.

The esterification catalyst, when present, may be used in amounts from 0.001 to 1% by weight of the total polymer components, such as from 0.01 to 0.2%, such as from 0.025 to 0.2% by weight of the total polymer components.

The coating composition may further comprise a liquid carrier, such as water and/or an organic solvent. The coating composition may comprise water and/or a single solvent or a mixture of solvents. The coating composition may comprise water, an organic solvent, a mixture of water and an organic solvent or a mixture of organic solvents. The coating composition may comprise water and an organic solvent or water and a mixture of organic solvents.

The liquid carrier may comprise ≥10% water by total liquid carrier weight, such as or ≥30 wt % or ≥50 wt %. A coating composition may be obtainable by dissolving and/or dispersing components comprising the (co)polymer(A)-acrylic block copolymer in a continuous phase that comprises water, such as with a liquid carrier comprising ≥10% water by total liquid carrier weight, such as or ≥30 wt % or ≥50 wt. Said continuous phase may optionally also comprise water miscible organic solvents.

The coating composition may be an aqueous coating composition. An aqueous coating composition may represent a coating composition obtainable by dissolving and/or dispersing components comprising the (co)polymer(A)-acrylic block copolymer in an aqueous medium.

The (co)polymer(A)-acrylic block copolymer may be substantially water dispersible.

The liquid carrier may comprise >50% organic solvent by total liquid carrier weight, such as >70 wt %, or >90 wt %.

The organic solvent may have sufficient volatility to essentially entirely evaporate from the coating composition during the curing process. As a non-limiting example, the curing process may be by heating at from 130 to 260° C. for from 5 seconds to 15 minutes. The coating composition may be an organic solventborne coating composition.

The organic solvent may comprise: aliphatic hydrocarbons such as mineral spirits and high flash point naphtha; aromatic hydrocarbons such as benzene; toluene; xylene; solvent naphtha 100, 150, 200; those available from Exxon-Mobil Chemical Company under the SOLVESSO® trade name; alcohols such as ethanol; n-propanol; isopropanol; n-butanol; pentanol; amyl alcohol; 1-methoxy-2-propanol; and butoxy ethanol; ketones such as acetone; cyclohexanone; methylisobutyl ketone; methyl ethyl ketone; esters such as ethyl acetate; butyl acetate; n-hexyl acetate; RHODIASOLV® RPDE (a blend of succinic and adipic esters commercially available from Rhodia); glycols such as butyl glycol; glycol ethers such as methoxypropanol; ethylene glycol monomethyl ether; ethylene glycol monobutyl ether; those available from Dow under the DOWANOL® trade name, such as DOWANOL PM, DOWANOL DPM and DOWANOL PPH, for example; and combinations thereof.

The (co)polymer(A)-acrylic block copolymer may be dissolved or dispersed in the said solvent during and/or after its formation.

The coating composition may comprise other optional materials well known in the art of formulating coatings, such as colorants, plasticizers, abrasion-resistant particles, anti-oxidants, hindered amine light stabilizers, UV light absorbers and stabilizers, surfactants, flow control agents, thixotropic agents, fillers, organic co-solvents, reactive diluents, catalysts, grind vehicles, lubricants, waxes and other customary auxiliaries.

As used herein, the term “colorant” means any substance that imparts colour and/or other opacity and/or other visual effect to the composition. The colorant can be added to the coating in any suitable form, such as discrete particles, dispersions, solutions and/or flakes. A single colorant or a mixture of two or more colorants can be used in the coatings of the present disclosure. Suitable colorants are listed in U.S. Pat. No. 8,614,286, column 7, line 2 through column 8, line 65, which is incorporated by reference herein. Colourant suitable for packaging coatings are those approved for food contact, such as titanium dioxide; iron oxides, such as black iron oxide; aluminium paste; aluminium powder such as aluminium flake; carbon black; ultramarine blue; phthalocyanines, such as phthalocyanine blue and phthalocyanine green; chromium oxides, such as chromium green oxide; graphite fibrils; ferried yellow; quindo red; and combinations thereof, and those listed in Article 178.3297 of the Code of Federal Regulations, which is incorporated by reference herein.

The colorant, when present, may be used in the coating composition in any suitable amount. The coating composition may comprise up to 90 wt %, such as up to 50 wt %, or even up to 10 wt % colorant, when present, based on the total solid weight of the coating composition.

Suitable lubricants will be well known to the person skilled in the art. Examples of lubricants include, but are not limited to the following: carnauba wax and polyethylene type lubricants. The coating composition may comprise at least 0.01 wt % lubricant, when present, based on the total solid weight of the coating composition.

Surfactants may optionally be added to the coating composition in order to aid in flow and wetting of the substrate. Suitable surfactants will be well known to the person skilled in the art. The surfactant, when present, may be chosen to be compatible with food and/or beverage container applications. The surfactant may comprise: alkyl sulphates (e.g., sodium lauryl sulphate); ether sulphates; phosphate esters; sulphonates; and their various alkali, ammonium, amine salts; aliphatic alcohol ethoxylates; alkyl phenol ethoxylates (e.g. nonyl phenol polyether); salts and/or combinations thereof. The coating composition may comprise from 0.01 wt % to 10 wt %, such as from 0.01 to 5 wt %, or even from 0.01 to 2 wt % surfactant, when present, based on the total solid weight of the coating composition.

The coating composition may comprise a crosslinking material. The coating composition may comprise any suitable crosslinking material. Suitable crosslinking materials will be well known to the person skilled in the art.

The crosslinking material may be operable to crosslink the (co)polymer(A). The crosslinking material may be a single molecule, a dimer, an oligomer, a (co)polymer or a mixture thereof. The crosslinking material may be a dimer or trimer.

The crosslinking material may comprise: phenolic resins (or phenol-formaldehyde resins); aminoplast resins (or triazine-formaldehyde resins); amino resins; epoxy resins; isocyanate resins; beta-hydroxy (alkyl) amide resins; alkylated carbamate resins, such as trisalkoxycarbamatotriazin (TACT); polyacids; anhydrides; organometallic acid-functional materials; polyamines; and/or polyamides and combinations thereof.

Suitable examples of phenolic resins are those formed from the reaction of a phenol with an aldehyde or a ketone, such as from the reaction of a phenol with an aldehyde, such as from the reaction of a phenol with formaldehyde or acetaldehyde, or even from the reaction of a phenol with formaldehyde. Non-limiting examples of phenols which may be used to form phenolic resins are phenol, butyl phenol, xylenol and cresol. General preparation of phenolic resins is described in “The Chemistry and Application of Phenolic Resins or Phenoplasts”, Vol V, Part I, edited by Dr Oldring; John Wiley and Sons/Cita Technology Limited, London, 1997. The phenolic resins may be of the resol type. By “resol type” is meant resins formed in the presence of a basic (alkaline) catalyst and optionally an excess of formaldehyde. Suitable examples of commercially available phenolic resins include, but are not limited to those sold under the trade name PHENODUR® commercially available from Allnex, such as PHENODUR EK-827, PHENODUR VPR1785, PHENODUR PR 515, PHENODUR PR516, PHENODUR PR 517, PHENODUR PR 285, PHENODUR PR612 or PHENODUR PH2024; resins sold under the trade name BAKELITE® commercially available from Sumitomo Bakelite co., ltd., such as BAKELITE 6582 LB, BAKELITE 6535, BAKELITE PF9989 or BAKELITE PF6581; SFC 112 commercially available from SI Group; DUREZ® 33356 commercially available from SHHPP; ARALINK® 40-852 commercially available from Bitrez; or combinations thereof.

Suitable examples of isocyanate resins include, but are not limited to the following: isophorone diisocyanate (IPDI), such as those sold under the trade name DESMODUR® commercially available from Covestro, for example DESMODUR VP-LS 2078/2 or DESMODUR PL 340 or those sold under the trade name VESTANAT® commercially available from Evonik, for example VESTANANT B 1370, VESTANAT B 118 6A or VESTANAT B 1358 A; blocked aliphatic polyisocyanate based on hexamethylene diisocyanate (HDI), such as those sold under the trade name DESMODUR® commercially available from Covestro, for example DESMODUR BL3370 or DESMODUR BL 3175 SN, those sold under the trade name DURANATE® commercially available from Asahi KASEI, for example DURANATE MF-K60X, those sold under the trade name TOLONATE® commercially available from Vencorex Chemicals, for example TOLONATE D2 or those sold under the trade name TRIXENE® commercially available from Baxenden, for example TRIXENE-BI-7984 or TRIXENE 7981; or combinations thereof.

The crosslinking material may contain nitrogen. The crosslinking material may be in the form of an amine or amide material. The crosslinking material may comprise a hydroxyl substituted amine or amide material.

The crosslinking material may comprise a hydroxyalkylamide material, such as a β-hydroxyalkylamide material.

The crosslinking material may comprise a commercially available β-hydroxyalkylamide crosslinking, such as, for example, PRIMID XL-552 (available from EMS); PRIMID QM-1260 (available from EMS Chemie); and N,N,N′,N′-tetrakis(2-hydroxypropyl) adipamide.

The crosslinking material may be in the form of a urea material. The crosslinking material may comprise a hydroxyl substituted urea material. The crosslinking material may comprise a hydroxy functional alkyl polyurea material.

The hydroxy functional alkyl polyurea material may comprise a material according to formula (I):

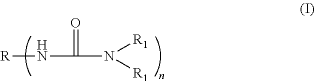

wherein R comprises an isocyanurate moiety, biuret moiety, allophonate moiety, glycoluril moiety, benzoguanamine moiety, polyetheramine moiety, and/or polymeric moiety different from a polyetheramine and having an Mn of 500 or greater; wherein each R1 is independently a hydrogen, alkyl having a carbon, or a hydroxy functional alkyl having 2 or more carbons and at least one R1 is a hydroxy functional alkyl having 2 or more carbons; and n is 2-6.

The hydroxy functional alkyl polyurea material may comprise a material according to formula (II):

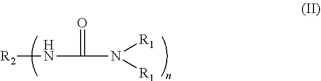

wherein R2 is a substituted or unsubstituted C1 to C36 alkyl group, an aromatic group, an isocyanurate moiety, biuret moiety, allophonate moiety, glycoluril moiety, benzoguanamine moiety, polyetheramine moiety, and/or polymeric moiety different from a polyetheramine and having an Mn of 500 or greater; wherein each R1 is independently a hydrogen, an alkyl having a carbon, or a hydroxy functional alkyl having 2 or more carbons and at least one R1 is a hydroxyl functional alkyl having 2 or more carbons; and n is 2-6.

Further details of suitable hydroxy functional alkyl polyurea materials are disclosed in PCT patent application WO 2017/123955, the entire contents of which are fully incorporated herein by reference.

Suitable examples of aminoplast resins include those which are a reaction product of a reaction mixture comprising a triazine such as melamine or benzoguanamine and formaldehyde. These condensates may be etherified, such as with methanol, ethanol, butanol or mixtures thereof. For the chemistry, preparation and use of aminoplast resins, see “The Chemistry and Applications of Amino Crosslinking agents or Aminoplast”, Vol. V, Part 11, page 21 ff., edited by Dr. Oldring; John Wiley & Sons/Cita Technology Limited, London, 1998. Suitable examples of commercially available aminoplast resins include, but are not limited to, those sold under the trade name MAPRENAL (registered trade mark), such as MAPRENAL MF980 (commercially available from Ineos); those sold under the trade name CYMEL (registered trade mark), such as CYMEL 303 and CYMEL 1128 (available from Allnex Industries); and combinations thereof.

The crosslinking material may comprise material according to formula (III)

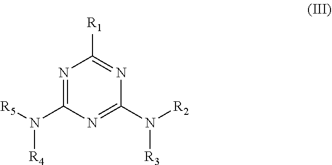

wherein R₁ represents hydrogen, alkyl (such as C₁ to C₂₀ alkyl), aryl (such as C₄ to C₂₄ aryl), aralkyl (such as C₈ to C₂₅ aralkyl), or —NR₆R₇;
R₂ to R₇ each independently represent hydrogen, alkyl (such as C₁ to C₂₀ alkyl), aryl (such as C₄ to C₂₄ aryl), aralkyl (such as C₈ to C₂₅ aralkyl) or —CHR₈OR₉;
wherein R₈ and R₉ each independently represent hydrogen, alkyl (such as C₁ to C₂₀ alkyl), aryl (such as C₄ to C₂₄ aryl), aralkyl (such as C₅ to C₂₅ aralkyl), alkoxyalkyl (such as C₂ to C₄₀ alkoxyalkyl) or an alkaryl (such as C₈ to C₂₅ alkaryl);
wherein at least one of R₂ to R₅, or R₂ to R₇ when present, is —CHR₈OR₉, for example all of R₂ to R₅, or R₂ to R₇ when present, may be —CHR₈OR₉.

In the crosslinking material according to formula (III), R1 may be C1 to C20 alkyl, C4 to C24 aryl, C5 to C25 aralkyl, or —NR6R7; such as C4 to C24 aryl or C5 to C25 aralkyl, or C4 to C24 aryl, such as C4 to C12 aryl, such as C6 aryl.

In the crosslinking material according to formula (III), R1 may be —NR6R7.

In the crosslinking material according to formula (III), R2 to R7, when present as applicable, may each be independently hydrogen, C1 to C20 alkyl, C4 to C24 aryl or —CHR8OR9; such as hydrogen, C1 to C20 alkyl or —CHR8OR9, such as hydrogen, C1 to C10 alkyl or —CHR8OR9; such as C1 to C5 alkyl or —CHR8OR9, such as —CHR8OR9.

In the crosslinking material according to formula (III), R2 to R7, when present as applicable, may each be independently hydrogen, C1 to C20 alkyl, C4 to C24 aryl or —CHR8OR9; such as hydrogen, C1 to C20 alkyl or —CHR8OR9, such as hydrogen, C1 to C10 alkyl or —CHR8OR9; such as C1 to C5 alkyl or —CHR8OR9, such as —CHR8OR9, and R8 may be independently be hydrogen, C1 to C20 alkyl, C4 to C24 aryl, C5 to C25 aralkyl, alkoxyalkyl C2 to C40 alkoxyalkyl or C5 to C25 alkaryl, such as hydrogen, C1 to C20 alkyl, such as hydrogen; and R9 may be hydrogen, C1 to C20 alkyl, C4 to C24 aryl, C5 to C25 aralkyl, alkoxyalkyl C2 to C40 alkoxyalkyl or C5 to C25 alkaryl; such as hydrogen, C1 to C20 alkyl; such as C1 to C20 alkyl, or C1 to C10 alkyl, or C1 to C5 alkyl, such as C1 or C2 alkyl.

The crosslinking material according to formula (III) may be a reaction product of a reaction mixture comprising a triazine such as melamine or benzoguanamine and formaldehyde. These condensates may be etherified, such as with methanol, ethanol, butanol or mixtures thereof. For the chemistry, preparation and use of aminoplast resins, see “The Chemistry and Applications of Amino Crosslinking agents or Aminoplast”, Vol. V, Part 11, page 21 ff., edited by Dr. Oldring; John Wiley & Sons/Cita Technology Limited, London, 1998.

The crosslinking material according to formula (III) may comprise melamine or derivatives thereof, such as butylated and/or methylated melamine; and/or benzoguanamine or derivatives thereof, such as butylated and/or methylated benzoguanamine. The crosslinking material according to formula (III) may comprise benzoguanamine or derivatives thereof, such as butylated and/or methylated benzoguanamine.

The crosslinking material may comprise those which are the reaction product of a reaction mixture comprising a triazine, such as melamine or benzoguanamine, and formaldehyde. The crosslinking material may comprise benzoguanamine or a derivative thereof.

The benzoguanamine or derivative thereof may comprise commercially available benzoguanamine or derivative thereof. Suitable examples of commercially available benzoguanamine and its derivatives include, but are not limited to benzoguanamine-formaldehyde based materials such as those sold under the trade name CYMEL (registered trade mark), for example CYMEL 1123 (commercially available from Allnex Industries), those sold under the trade name ITAMIN (registered trade mark), for example ITAMIN BG143 (commercially available from Galstaff Multiresine) or those sold under the trade name MAPRENAL (registered trade mark), for example, MAPRENAL BF892 and MAPRENAL BF 892/68B (commercially available from Ineos); glycoluril based materials, such as those sold under the trade name CYMEL (registered trade mark), for example, CYMEL 1170 and CYMEL 1172 (commercially available from Allnex); and combinations thereof.

The benzoguanamine or derivative thereof may comprise benzoguanamine-formaldehyde based materials sold under the trade name MAPRENAL (registered trade mark).

The benzoguanamine or derivative thereof may comprise MAPRENAL BF892, MAPRENAL BF 892/68B and/or MAPRENAL MF-984 (commercially available from Ineos).

Further details of a suitable crosslinker are disclosed in published EP patent application EP3161080 A1, specifically, paragraphs to inclusive and paragraph

The entire contents paragraphs to and are fully incorporated herein by reference.

The coating composition, such as a coating composition comprising a (co)polymer(A)-acrylic block copolymer obtainable from a (co)polymer(A)-precursor comprising a substantially terminal hydroxyl-group, may comprise an aminoplast crosslinker, such as a benzoguanamine or a derivative thereof, and a further crosslinker, such as a phenolic resin.

The coating composition, such as a coating composition comprising a (co)polymer(A)-acrylic block copolymer obtainable from a (co)polymer(A)-precursor comprising a substantially terminal carboxylic acid-group, may comprise a phenolic resin.

The crosslinking material may be present in the coating composition in any suitable amount.

The coating composition may comprise at least 0.5 wt % crosslinking material based on the total solid weight of the coating composition. Such as at least 1 wt %, or at least 5 wt % crosslinking material based on the total solid weight of the coating composition.

The coating composition, such as a coating composition comprising a (co)polymer(A)-acrylic block copolymer obtainable from a (co)polymer(A)-precursor comprising a substantially terminal hydroxyl-group, may comprise at least 0.5 wt % crosslinking material based on the total solid weight of the coating composition. Such as at least 1 wt %, at least 5 wt %, at least 10 wt % crosslinking material based on the total solid weight of the coating composition.

The coating composition may comprise up to 70 wt % crosslinking material based on the total solid weight of the coating composition. Such as up to 60 wt %, up to 50 wt %, up to 40 wt %, up to 30 wt %, up to 25 wt %, or up to 20 wt % crosslinking material based on the total solid weight of the coating composition.

The coating composition may comprise from 0.5 to 90 wt %, or 1 to 90 wt %, such as from 1 to 80 wt %, such as from 1 to 70 wt %, such as from 1 to 60 wt %, such as from 1 to 50 wt %, such as from 1 to 40 wt %, such as from 1 to 30 wt %, or even from 1 to 25 wt % crosslinking material based on the total solid weight of the coating composition. The coating composition may comprise from 5 to 90 wt %, such as from 5 to 80 wt %, such as from 5 to 70 wt %, such as from 5 to 60 wt %, such as from 5 to 50 wt %, such as from 5 to 40 wt %, such as from 5 to 30 wt %, or even from 5 to 25 wt % crosslinking material based on the total solid weight of the coating composition.

The coating composition, such as a coating composition comprising a (co)polymer(A)-acrylic block copolymer obtainable from a (co)polymer(A)-precursor comprising a substantially terminal hydroxyl-group, may comprise from 10 to 90 wt %, such as from 10 to 80 wt %, such as from 10 to 70 wt %, such as from 10 to 60 wt %, such as from 10 to 50 wt %, such as from 10 to 40 wt %, such as from 10 to 30 wt %, or even from 10 to 25 wt %, or 10 to 20 wt %, crosslinking material based on the total solid weight of the coating composition.

The coating compositions may further comprise a catalyst. Any catalyst suitable to catalyse crosslinking reactions between the (co)polymer(A)-acrylic block copolymer and/or any crosslinking agent may be used. Suitable catalysts will be well known to the person skilled in the art. The catalyst may be a non-metal or a metal catalyst or a combination thereof. A non-metal catalyst may comprise: phosphoric acid; blocked phosphoric acid; CYCAT® XK 406 N (commercially available from Allnex); sulfuric acid; sulfonic acid; CYCAT 600 (commercially available from Allnex); NACURE® 5076 or NACURE 5925 (commercially available from King industries); acid phosphate catalyst such as NACURE XC 235 (commercially available from King Industries); and combinations thereof. Suitable metal catalysts will be well known to the person skilled in the art. A metal catalyst may comprise: tin containing catalysts, such as monobutyl tin tris (2-ethylhexanoate); zirconium containing catalysts, such as KKAT® 4205 (commercially available from King Industries); titanate based catalysts, such as tetrabutyl titanate TnBT (commercially available from Sigma Aldrich); and combinations thereof.

Suitable examples of catalysts may include, but are not limited to the following: metal compounds such as stannous octoate; stannous chloride; butyl stannoic acid (hydroxy butyl tin oxide); monobutyl tin tris (2-ethylhexanoate); chloro butyl tin dihydroxide; tetra-n-propyl titanate; tetra-n-butyl titanate; zinc acetate; acid compounds such as phosphoric acid; para-toluene sulphonic acid; dodecyl benzene sulphonic acid (DDBSA) such as blocked DDBSA, tetra alkyl zirconium materials, antimony trioxide, germanium dioxide and combinations thereof. The catalyst may comprise dodecyl benzene sulphonic acid (DDBSA), such as blocked DDBSA.

The catalyst, when present, may be used in the coating composition in any suitable amount. The catalyst may be present in the coating composition in an amount of ≥0.001% by solid weight of the coating composition coating composition, such as ≥0.01%, such as ≥0.025% by solid weight of the coating composition. The catalyst may be present in the coating composition in an amount of ≤1% by solid weight of the coating composition coating composition, such as ≤0.7%, such as ≤0.5% by solid weight of the coating composition. The catalyst may be present in the coating composition in amounts from 0.001 to 1% by solid weight of the coating composition coating composition, such as from 0.01 to 0.7%, such as from 0.025 to 0.5% by solid weight of the coating composition.

The coating composition may comprise ≤1% by solid weight of the coating composition of a curing catalyst additive, such as ≤0.7 wt %, ≤0.5 wt %, ≤0.25 wt %, ≤0.1 wt %, ≤0.05 wt %, ≤0.025 wt %, ≤0.01 wt % or ≤0.001 wt %. As used herein “curing catalyst additive” means a component added to the composition, in addition to the copolymer additive of the disclosure comprising a sulfonic acid-, a sulfate-, a phosphonic acid- and/or a phosphate-functional group, that is operable to catalyse crosslinking reactions between the polyester-acrylic block and/or any crosslinking agent. The curing catalyst additive may be a metal compound such as stannous octoate; stannous chloride; butyl stannoic acid (hydroxy butyl tin oxide); monobutyl tin tris (2-ethylhexanoate); chloro butyl tin dihydroxide; tetra-n-propyl titanate; tetra-n-butyl titanate; zinc acetate; an acid compound such as phosphoric acid; para-toluene sulphonic acid; dodecyl benzene sulphonic acid (DDBSA) such as blocked DDBSA, tetra alkyl zirconium materials, antimony trioxide, germanium dioxide and combinations thereof. The curing catalyst additive may be dodecyl benzene sulphonic acid and/or para-toluene sulphonic acid. The curing catalyst additive may be a small molecule curing catalyst additive. A small molecule curing catalyst additive may be a non-polymeric curing catalyst additive and/or a curing catalyst additive having a molecular weight of <1,000 Da, such as ≤800 Da or ≤500 Da. The coating compositions may be substantially free, may be essentially free or may be completely free of a curing catalyst additive. “Substantially free” refers to coating compositions, or components thereof, containing less than 1000 parts per million (ppm) of a curing catalyst additive. “Essentially free” refers to coating compositions, or components thereof, containing less than 100 ppm of any of a curing catalyst additive. “Completely free” refers to coating compositions, or components thereof, containing less than 20 parts per billion (ppb) of a curing catalyst additive.

The coating composition may have any suitable solids content. The coating composition may have a solids content of from 20 to 50% by weight of the coating composition, such as from 25 to 45 wt % or such as from 30 to 40 wt %.

A cured film formed from the coating composition of the present disclosure, such as a coating composition comprising a (co)polymer(A)-acrylic block copolymer obtainable from a (co)polymer(A)-precursor comprising a substantially terminal hydroxyl-group, may have a hairing of ≤3, such as ≤2.

As reported herein, hairing is a measure of any coating fiber defect build up during coil stamping. Depending on the severity of built up, 5 levels of grade of hairing were used to measure the hairing at the shell punch stage: 1 means no hairing, 2 means slight hairing, 3 means moderate hairing, 4 means heavy hairing, 5 means severe hairing.

A cured film formed from the coating composition of the present disclosure may have any suitable glass transition temperature (Tg). A cured film may have a Tg of ≥25° C. and/or ≤200° C. A coating formed from the coating composition may have a Tg of ≥25º, or ≥30° C., or ≥35° C., such as >40° C. or >45° C., or ≥50° C., such as ≥55° C. or ≥60° C. A cured film may have a Tg of ≤200° C. such as ≤150° C., or ≤120° C., or ≤110° C., or ≤105° C. A cured film may have a Tg of from 25° C. to 200° C., such as from 40° C. to 150° C., such as from 50° C. to 120° C., or from 50° C. to 110° C., such as from 60° C. to 105° C.

A cured film formed from the coating composition of the present disclosure, such as a coating composition comprising a (co)polymer(A)-acrylic block copolymer obtainable from a (co)polymer(A)-precursor comprising a substantially terminal hydroxyl-group, may have a film weight of 0.5 to 10 mg/in². A cured film formed from the coating composition of the present disclosure having a film weight of 2 mg/in² may have an enamel rating before pack of ≤75 mA, such as ≤50 mA or ≤25 mA≤10 mA. A cured film formed from the coating composition of the present disclosure having a film weight of 7 mg/in² may have an enamel rating before pack of ≤5 mA, such as ≤2 mA, or ≤1 mA.

As reported herein, the enamel rating was measured as follows: 47 grams of the stock solution of L-85 was added to the can followed by the addition of 308 grams of carbonated water. A 202 type seamer was then used to seam an end onto the can. The can was then placed upside down (inverted) into a 100° F. (38° C.) incubator for 10 days. The can was then removed from the incubator, opened, and then measured using the Waco Enamel Rater test in which electrolyte was added to the plastic cup of Waco Enamel Rater, the can end was fitted onto the beveled end of the cup, and a vacuum applied to hold the end securely on the cup. When the cup was inverted, the electrode and can end were immersed in the electrolyte and the reading was displayed on the Enamel Rater.

A cured film formed from the coating composition of the present disclosure, such as a coating composition comprising a (co)polymer(A)-acrylic block copolymer obtainable from a (co)polymer(A)-precursor comprising a substantially terminal hydroxyl-group, may have a solvent fraction of ≤15%, such as ≤10% or ≤5%.

As reported herein, the solvent fraction was measured as follows: A four square inch disk was punched out in a hold puncher. The disk was then weighed on a four place balance. This was the “initial weight”. A sample was then placed into a rack and soaked in MEK (methyl ethyl ketone) for 10 minutes. Next, the sample was removed and placed into a 400° F. oven for 2 minutes, removed from the oven, cooled, and weighed again. This value was the “post bake weight”. Next, the disk was placed into Sulfuric Acid (A298-212 Technical Grade available from Fisher Scientific) for 3 minutes to strip the coating from the metal. The panel was rinsed with water to remove the coating completely. Then the panel was dried and re-weighed. This was the “final weight”. The equation used to determine Solvent Fraction was:

(Initial weight−Post Bake weight)/(Initial weight−Final weight)×100=Solvent Fraction

A “cured film” as used to measure hairing, Tg, enamel rating and solvent fraction properties of the film described herein means a film formed as follows. The coating composition was drawn down with a wire wound bar over a chromium pretreated aluminium panel (Henkel 702N, AA5182 Alloy) to give a dry film weight of 6.5-7.5 milligrams/square inch (msi), unless indicated otherwise. The panels were then baked in a three zone coil oven (249/326/293° C.) to a peak metal temperature of 240° C.

As used herein, “free film” means a film that was removed from a substrate that had been pre-treated with a lubricant that permitted the cured film to be peeled from the substrate.

The cured film used to measure properties described herein may be a dry film or a wet film. As reported herein, unless stated otherwise, “dry film” refers to a film that was formed by curing the coating composition to form a cured film and “wet film” refers to a film that was formed by curing the coating composition to form a cured film, which was then soaked in commercially available Coca Cola Classic at 38° C. (100° F.) for 24 hours before testing.

A cured film formed from the coating composition of the present disclosure, such as a coating composition comprising a (co)polymer(A)-acrylic block copolymer obtainable from a (co)polymer(A)-precursor comprising a substantially terminal carboxylic acid-group, may have a number of MEK double rubs of ≥10, such as ≥15 or ≥20.

As reported herein, the number of MEK double rubs was measured as follows. A cured film was manually rubbed in a back and forth motion using a clean cheesecloth soaked in methyl ethyl ketone attached to 2 lbs hammer. The number of double rubs (back and forth motion) that the coating survives prior to failure was recorded. Failure occurs when the coating was broken through to reveal the underlying substrate.

A cured film formed from the coating composition of the present disclosure, such as a coating composition comprising a (co)polymer(A)-acrylic block copolymer obtainable from a (co)polymer(A)-precursor comprising a substantially terminal carboxylic acid-group, may have a wedge bend in mm (% failure) of ≤75%, such as ≤60% or ≤30%.

As reported herein, the wedge mend in mm (% failure) was measured according to ASTM Method D 522-93. Coated panels were cut into 1.5×4 inch plaques for wedge bend testing. Coatings were evaluated for flex by how much % spotty failure was seen along the bent radius after soaking the panels for one minute in 10% aqueous copper sulfate solution after wedge bending them.

A cured film formed from the coating composition of the present disclosure, such as a coating composition comprising a (co)polymer(A)-acrylic block copolymer obtainable from a (co)polymer(A)-precursor comprising a substantially terminal carboxylic acid-group, may have a 3% acetic acid blister performance and/or a hard-to-hold blister performance of ≥4.

As reported herein, the 3% acetic acid resistance was measured as follows. A 3% stock solution was prepared by mixing 99 grams of Glacial Acetic Acid (product of Fisher Scientific) into 3201 grams of deionized water. Coated strips having a cured film were immersed into the boiling Acetic Acid solution for 30 minutes. The strips were then rinsed in deionized water, dried, and immediately rated for blister performance.

The ‘hard-to-hold’ performance may be as tested using stimulant acid solutions such as 0.01% orange oil/1% lactic acid solution and/or 0.25% formic acid solution. As reported herein, the hard-to-hold performance was measured as follows. Coated panels having a cured film were cut into 2×4 inch test panels and were soaked in the stimulant acid solution(s) for 10 days at 49° C. The test panels were then rated for blister performance.

As reported herein, ‘blister performance’ was assessed as follows. Blistering was measured visually using a scale of 0-5 where a rating of “5” indicates no blistering and a rating of “0” indicates delamination from the substrate. The coated panel tested was 2×4 inches (5×10 cm) and the testing solution covered half of the panel being tested.

A “cured film” as used to measure MEK, wedge bend, acetic acid resistance and hard-to-hold properties of the film described herein means a film formed as follows. The coating compositions were drawn down with a wire wound bar over zirconium-treated aluminium panel 380 F/3′ (0.00065 inch) to give a dry film weight of 1.8 to 2.3 milligrams/square inch (msi). The panels were then baked at 193° C. for 3 minutes.

The coating compositions of the present disclosure may be substantially free, may be essentially free or may be completely free of bisphenol A (BPA) and derivatives thereof. Derivatives of bisphenol A include, for example, bisphenol A diglycidyl ether (BADGE). The coating compositions of the present disclosure may also be substantially free, may be essentially free or may be completely free of bisphenol F (BPF) and derivatives thereof. Derivatives of bisphenol F include, for example, bisphenol F diglycidyl ether (BPFG). The compounds or derivatives thereof mentioned above may not be added to the composition intentionally but may be present in trace amounts because of unavoidable contamination from the environment. “Substantially free” refers to coating compositions, or components thereof, containing less than 1000 parts per million (ppm) of any of the compounds or derivatives thereof mentioned above. “Essentially free” refers to coating compositions, or components thereof, containing less than 100 ppm of any of the compounds or derivatives thereof mentioned above. By “Completely free” refers to coating compositions, or components thereof, containing less than 20 parts per billion (ppb) of any of the compounds or derivatives thereof mentioned above.

The coating compositions of the present disclosure may be substantially free, may be essentially free or may be completely free of dialkyltin compounds, including oxides or other derivatives thereof. Examples of dialkyltin compounds include, but are not limited to the following: dibutyltindilaurate (DBTDL); dioctyltindilaurate; dimethyltin oxide; diethyltin oxide; dipropyltin oxide; dibutyltin oxide (DBTO); dioctyltinoxide (DOTO) or combinations thereof. By “substantially free” we mean to refer to coating compositions containing less than 1000 parts per million (ppm) of any of the compounds or derivatives thereof mentioned above. By “essentially free” we mean to refer to coating compositions containing less than 100 ppm of any of the compounds or derivatives thereof mentioned above. By “completely free” we mean to refer to coating compositions containing less than 20 parts per billion (ppb) of any of the compounds or derivatives thereof.

The coating compositions may be substantially free, may be essentially free or may be completely free of formaldehyde. “Substantially free” refers to coating compositions, or components thereof, containing less than 1000 parts per million (ppm) of formaldehyde. “Essentially free” refers to coating compositions, or components thereof, containing less than 100 ppm of any of formaldehyde. “Completely free” refers to coating compositions, or components thereof, containing less than 20 parts per billion (ppb) of formaldehyde.

The coating compositions and/or layers deposited from the same, as well as any pretreatment layer, primer layer or topcoat layer, may be substantially free of chromium or chromium-containing compounds meaning that chromium or chromium-containing compounds are not intentionally added, but may be present in trace amounts, such as because of impurities or unavoidable contamination from the environment. In other words, the amount of material is so small that it does not affect the properties of the composition; this may further include that chromium or chromium-containing compounds are not present in an aqueous or powder composition and/or layers deposited from the same, as well as any pretreatment layer, primer layer or topcoat layer, in such a level that they cause a burden on the environment. The term “substantially free” means that a coating composition and/or layers deposited from the same, as well as any pretreatment layer, primer layer or topcoat layer, contain less than 10 ppm of chromium, based on total solids weight of the composition, the layer, or the layers, respectively, if any at all. The term “essentially free” means that a coating composition and/or layers deposited from the same, as well as any pretreatment layer, primer layer or topcoat layer, contain less than 1 ppm of chromium, based on total solids weight of the composition or the layer, or layers, respectively, if any at all. The term “completely free” means that a coating composition and/or layers comprising the same, as well as any pretreatment layer, primer layer or topcoat layer, contain less than 1 ppb of chromium, based on total solids weight of the composition, the layer, or the layers, respectively, if any at all.

The coating compositions of the present disclosure may be used to form a coating layer on a substrate. The coating layer may be a cured film, for example a cured film as defined herein.

The coating compositions may be applied to the substrate by any suitable method. Suitable methods of applying the coating compositions will be well known to a person skilled in the art. Suitable application methods for the coating compositions include, but are not limited to the following: spraying; electrostatic spraying; dipping; rolling; brushing; and the like.

The coating compositions may be applied to the substrate, or a portion thereof, as a single layer or as part of a multi layer system. The coating compositions may be applied as a single layer. The coating compositions may be applied to an uncoated substrate. For the avoidance of doubt an uncoated substrate extends to a surface that is cleaned prior to application. The coating compositions may be applied on top of another paint layer as part of a multi layer system. For example, the coating compositions may be applied on top of a primer. The coating compositions may form an intermediate layer or a top coat layer. The coating compositions may be applied as the first coat of a multi coat system. The coating compositions may be applied as an undercoat or a primer. The second, third, fourth etc. coats may comprise any suitable paint such as those containing, for example, epoxy resins; polyester resins; polyurethane resins; polysiloxane resins; hydrocarbon resins or combinations thereof. The second, third, fourth etc. coats may comprise polyester resins. The second, third, fourth etc. coats may be a liquid coating or a powder coating.

It will be appreciated by a person skilled in the art that the coating compositions may be applied before or after forming the article, such as the packaging. For example, the coating compositions may be applied to metal substrate which is then shaped and formed into a metal article, or the coating composition may be applied to the preformed article.

The coating compositions may be applied to a substrate once or multiple times.

Powder coating compositions may be applied by any suitable method. Methods of applying said powder coating compositions will be well known to a person skilled in the art. Suitable application methods include, such as electrodeposition, or applied by ultra corona discharge for example. The powder coating compositions may be applied by ultra corona discharge.

The coating compositions may be applied to any suitable dry film thickness. The coating compositions may be applied to a dry film thickness from 1 to 100 microns (μm), such as from 1 to 75 μm, such as from 1 to 50 μm, such as from 1 to 40 μm, such as from 1 to 20 μm, or even from 1 to 10 μm.

The coating compositions may be cured by any suitable method. The coating composition may be cured by heat curing, radiation curing or by chemical curing, such as by heat curing.

The coating composition, when heat cured, may be cured at any suitable temperature. The coating composition, when heat cured, may be cured to a peak metal temperature (PMT) of 100 to 350° C., such as 150 to 350° C., such as from 175 to 320° C., such as from 190 to 300° C., or even from 200 to 280° C. For the avoidance of doubt, the term “peak metal temperature”, and like terms as used herein, is meant unless specified otherwise the maximum temperature reached by the metal substrate during exposure to a heat during the heat curing process. In other words, the peak metal temperature (PMT) is the maximum temperature reached by the metal substrate and not the temperature which is applied thereto. It will be appreciated by a person skilled in the art that the temperature reached by the metal substrate may be lower than the temperature which is applied thereto or may be substantially equal to the temperature which is applied thereto. The temperature reached by the metal substrate may be lower that the temperature which is applied thereto.

Curing the coating compositions may form a cured film.

Further information about suitable application methods of applying suitable coating compositions to substrates will now be given.

A liquid coating composition may be electrophoretically deposited upon any electrically conductive substrate. Suitable substrates include metal substrates, metal alloy substrates, and/or substrates that have been metallized, such as nickel-plated plastic. Additionally, substrates may comprise non-metal conductive materials including composite materials such as, for example, materials comprising carbon fibers or conductive carbon. The metal or metal alloy may comprise, for example, cold rolled steel, hot rolled steel, steel coated with zinc metal, zinc compounds, or zinc alloys, such as electrogalvanized steel, hot-dipped galvanized steel, galvannealed steel, nickel-plated steel, and steel plated with zinc alloy. The substrate may comprise an aluminum alloy. Non-limiting examples of aluminum alloys include the 1XXX, 2XXX, 3XXX, 4XXX, 5XXX, 6XXX, or 7XXX series as well as clad aluminum alloys and cast aluminum alloys, such as, for example, the A356 series. The substrate may comprise a magnesium alloy. Non-limiting examples of magnesium alloys of the AZ31B, AZ91C, AM60B, or EV31A series also may be used as the substrate. The substrate may also comprise other suitable non-ferrous metals such as titanium or copper, as well as alloys of these materials.

The substrate may also comprise conductive or non-conductive substrates at least partially coated with a conductive coating. The conductive coating may comprise a conductive agent such as, for example, graphene, conductive carbon black, conductive polymers, or conductive additives. It will also be understood that the substrate may be pretreated with a pretreatment solution. Non-limiting examples of a pretreatment solution include a zinc phosphate pretreatment solution such as, for example, those described in U.S. Pat. Nos. 4,793,867 and 5,588,989, a zirconium containing pretreatment solution such as, for example, those described in U.S. Pat. Nos. 7,749,368 and 8,673,091. Other non-limiting examples of a pretreatment solution include those comprising trivalent chromium, hexavalent chromium, lithium salts, permanganate, rare earth metals, such as yttrium, or lanthanides, such as cerium. Another non-limiting example of a suitable surface pretreatment solution is a sol-gel, such as those comprising alkoxy-silanes, alkoxy-zirconates, and/or alkoxy-titanates. Alternatively, the substrate may be a non-pretreated substrate, such as a bare substrate, that is not pretreated by a pretreatment solution.

The substrate may optionally be subjected to other treatments prior to coating. For example, the substrate may be cleaned, cleaned and deoxidized, anodized, acid pickled, plasma treated, laser treated, or ion vapor deposition (IVD) treated. These optional treatments may be used on their own or in combination with a pretreatment solution.

A liquid composition of the disclosure may be utilized in a coating layer that is part of a multi-layer coating composite comprising a substrate with various coating layers. The coating layers may optionally include a pretreatment layer, such as a phosphate layer (e.g., zinc phosphate layer) or metal oxide layer (e.g., zirconium oxide layer), a coating layer which results from an aqueous composition of the disclosure, optionally primer layer(s) and suitable topcoat layer(s) (e.g., base coat, clear coat layer, pigmented monocoat, and color-plus-clear composite compositions). It is understood that suitable additional coating layers include any of those known in the art, and each independently may be waterborne, solventborne, in solid particulate form (i.e., a powder coating composition), or in the form of a powder slurry. The additional coating compositions may comprise a film-forming polymer, crosslinking material and, if a colored base coat or monocoat, pigment. The primer layer(s) may optionally be disposed between the electrocoating layer and the topcoat layer(s). Alternatively, the topcoat layer(s) may be omitted such that the composite comprises the coating layer of the disclosure and primer layer(s).

Moreover, the topcoat layer(s) may be applied directly onto the coating layer of the disclosure. In other words, the substrate may lack a primer layer such that the composite comprises the coating layer of the disclosure and topcoat layer(s). For example, a basecoat layer may be applied directly onto at least a portion of the coating layer of the disclosure.

It will also be understood that any of the topcoat layers may be applied onto an underlying layer despite the fact that the underlying layer has not been fully cured. For example, a clearcoat layer may be applied onto a basecoat layer even though the basecoat layer has not been subjected to a curing step (wet-on-wet). Both layers may then be cured during a subsequent curing step thereby eliminating the need to cure the basecoat layer and the clearcoat layer separately.

The coating composition may be a powder coating composition.

When the substrate is electrically conductive, the powder coating composition may be electrostatically applied. Electrodeposition generally involves drawing the coating composition from a fluidized bed and propelling it through a corona field. The particles of the coating composition become charged as they pass through the corona field and are attracted to and deposited upon the electrically conductive substrate, which is grounded. As the charged particles begin to build up, the substrate becomes insulated, thus limiting further particle deposition.

The coating compositions may be applied to the substrate by spraying. Thus, the coating compositions may be spray compositions. For the avoidance of doubt, by the term ‘spray composition’ and like terms as used herein is meant, unless specified otherwise, that the coating is suitable to be applied to a substrate by spraying, i.e. is sprayable.

The coating compositions may be applied to any suitable substrate. The substrate may be formed of metal, plastic, composite and/or wood. The substrate may be a metal substrate.

Suitable metals include, but are not limited to, the following: steel; tinplate; tinplate pre-treated with a protective material such as chromium, titanium, titanate or aluminium; tin-free steel (TFS); galvanised steel, such as for example electro-galvanised steel; aluminium; aluminium alloy; and combinations thereof.

The substrate may form an article, or a part thereof. The part to be coated may be in the shape of a cylinder, such as a pipe, including, for example, a cast iron or steel pipe. The metal substrate also may be in the form of, for example, a sheet of metal or a fabricated part.

The article may include a package or packaging; an automotive article; a marine article; a household or office appliance; lumber; wood flooring; furniture item or tool; apparel; an industrial article, such as a powered industrial article; heavy-duty equipment; electronics, including housings and circuit boards and including consumer electronics; glass and transparencies; sports equipment including golf balls, and the like; an architectural article; an article protected by an intumescent coating; or a structure; or a part thereof.

Examples of suitable metal substrates or articles include, but are not limited to, a food and/or beverage package or packaging, components used to fabricate such a package or packaging, or monobloc aerosol cans and/or tubes.

The food and/or beverage package may be a can, such as a metal can. Examples of cans include, but are not limited to, two-piece cans, three-piece cans and the like. The food and/or beverage package may be a two-piece metal can. Suitable examples of monobloc aerosol cans and/or tubes include, but are not limited to, deodorant and hair spray containers. Monobloc aerosol cans and/or tubes may be aluminium monobloc aerosol cans and/or tubes.

The substrate or article may be a food and/or beverage package or packaging, or component used to fabricate such package or packaging.

The food and/or beverage can may comprise a can body and a can end.

The substrate or article may be a monobloc aerosol can and/or tube.

The application of various pre-treatments and coatings to packaging is well established. Such treatments and/or coatings, for example, can be used in the case of metal cans, wherein the treatment and/or coating is used to retard or inhibit corrosion, provide a decorative coating, provide ease of handling during the manufacturing process, and the like. Coatings can be applied to the interior of such cans to prevent the contents from contacting the metal of the container. Contact between the metal and a food or beverage, for example, can lead to corrosion of a metal container, which can then contaminate the food or beverage. For example, when the contents of the can are acidic in nature. The coatings applied to the interior of metal cans also help prevent corrosion in the headspace of the cans, which is the area between the fill line of the product and the can lid; corrosion in the headspace may be problematic with food products having a high salt content. Coatings can also be applied to the exterior of metal cans.

The coating compositions may be applicable for use with coiled metal stock, such as the coiled metal stock from which the ends of cans are made (“can end stock”), and end caps and closures are made (“cap/closure stock”). Since coatings designed for use on can end stock and cap/closure stock may be applied prior to the piece being cut and stamped out of the coiled metal stock, they may be flexible and extensible. For example, such stock may be coated on both sides. Thereafter, the coated metal stock is punched. For can ends, the metal is then scored for the “pop-top” opening and the pop-top ring is then attached with a pin that is separately fabricated.

The end is then attached to the can body by an edge rolling process. A similar procedure is done for “easy open” can ends. For easy open can ends, a score substantially around the perimeter of the lid allows for easy opening or removing of the lid from the can, such as by means of a pull tab. For caps and closures, the cap/closure stock may be coated, such as by roll coating, and the cap or closure stamped out of the stock; it is possible, however, to coat the cap/closure after formation. Coatings for cans subjected to relatively stringent temperature and/or pressure requirements should also be resistant to popping, corrosion, blushing and/or blistering.

The substrate or article may be a can end, such as a metal can end.

The substrate or article may be a package coated at least in part with any of the coating compositions described herein. A “package” is anything used to contain another item, such as for shipping from a point of manufacture to a consumer, and for subsequent storage by a consumer. A package will be therefore understood as something that is sealed so as to keep its contents free from deterioration until opened by a consumer. The manufacturer will often identify the length of time during which the food or beverage will be free from spoilage, which may range from several months to years. Thus, the present “package” is distinguished from a storage container or bakeware in which a consumer might make and/or store food; such a container would only maintain the freshness or integrity of the food item for a relatively short period. A package according to the present disclosure can be made of metal or non-metal, for example, plastic or laminate, and be in any form. An example of a suitable package is a laminate tube. Another example of a suitable package is metal can. The term “metal can” includes any type of metal can, container or any type of receptacle or portion thereof that is sealed by the food and/or beverage manufacturer to minimize or eliminate spoilage of the contents until such package is opened by the consumer. One example of a metal can is a food can; the term “food can(s)” is used herein to refer to cans, containers or any type of receptacle or portion thereof used to hold any type of food and/or beverage. The term “metal can(s)” specifically includes food cans and also specifically includes “can ends” including “E-Z open ends”, which may be stamped from can end stock and used in conjunction with the packaging of food and beverages. The term “metal cans” also specifically includes metal caps and/or closures such as bottle caps, screw top caps and lids of any size, lug caps, and the like. The metal cans can be used to hold other items as well, including, but not limited to, personal care products, bug spray, spray paint, and any other compound suitable for packaging in an aerosol can. The cans can include “two piece cans” and “three-piece cans” as well as drawn and ironed one-piece cans; such one piece cans often find application with aerosol products. Packages coated according to the present disclosure can also include plastic bottles, plastic tubes, laminates and flexible packaging, such as those made from PE, PP, PET and the like. Such packaging could hold, for example, food, toothpaste, personal care products and the like.

The coating compositions can be applied to the interior and/or the exterior of the package or packaging. The coating compositions could also be applied as a rim coat to the bottom of the can. The rim coat functions to reduce friction for improved handling during the continued fabrication and/or processing of the can. The coating compositions can also be applied to caps and/or closures; such application can include, for example, a protective varnish that is applied before and/or after formation of the cap/closure and/or a pigmented enamel post applied to the cap, such as those having a scored seam at the bottom of the cap. Decorated can stock can also be partially coated externally with the coating described herein, and the decorated, coated can stock used to form various metal cans.

Metal coils, having wide application in many industries, are also substrates that can be coated according to the present disclosure. Coil coatings may comprise a colorant.

An automotive article may be a vehicle or any part thereof. Any part or any surface of the vehicle which may undergo coating to improve a property thereof (for example its luster, scratch resistance, corrosion resistance or UV resistance) may be a coating with a composition as defined herein.

The term “vehicle” is used in its broadest sense and includes (without limitation) all types of vehicles, such as but not limited to aircraft, spacecraft, watercraft, and ground vehicles. For example, a vehicle can include aircraft such as airplanes including private aircraft, and small, medium, or large commercial passenger, freight, and military aircraft; helicopters, including private, commercial, and military helicopters; aerospace vehicles including, rockets and other spacecraft. Vehicles can include ground vehicles such as, for example, trailers, cars, trucks, buses, coaches, vans, ambulances, fire engines, motorhomes, caravans, go-karts, buggies, fork-lift trucks, sit-on lawnmowers; agricultural vehicles such as, for example, tractors and harvesters; construction vehicles such as, for example, diggers, bulldozers and cranes; golf carts, motorcycles, bicycles, trains, subway cars and railroad cars. Vehicles can also include watercraft such as, for example, ships, submarines, boats, jet-skis and hovercraft.

The vehicle may comprise a F/A-18 jet or related aircraft such as the F/A-18E Super Hornet and F/A-18F (produced by McDonnell Douglas/Boeing and Northrop); the Boeing 787 Dreamliner, 737, 747, 717 passenger jet aircraft, and related aircraft (produced by Boeing Commercial Airplanes); the V-22 Osprey; VH-92, S-92, and related aircraft (produced by NAVAIR and Sikorsky); the G650, G600, G550, G500, G450, and related aircraft (produced by Gulfstream); or the A350, A320, A330, and related aircraft (produced by Airbus). The coating composition may be used as a coating for use in any suitable commercial, military, or general aviation aircraft such as, for example, those produced by Bombardier Inc. and/or Bombardier Aerospace such as the Canadair Regional Jet (CRJ) and related aircraft; produced by Lockheed Martin such as the F-22 Raptor, the F-35 Lightning, and related aircraft; produced by Northrop Grumman such as the B-2 Spirit and related aircraft; produced by Pilatus Aircraft Ltd.; produced by Eclipse Aviation Corporation; or produced by Eclipse Aerospace (Kestrel Aircraft).

Parts of vehicles coated in accordance with the present disclosure may include vehicular body parts (e.g., without limitation, doors, body panels, trunk deck lids, roof panels, hoods, roofs and/or stringers, rivets, wheels, landing gear components, and/or skins used on an aircraft), hulls, marine superstructures, vehicular frames, chassis, and vehicular parts not normally visible in use, such as engine parts, motorcycle fairings and fuel tanks, fuel tank surfaces and other vehicular surfaces exposed to or potentially exposed to fuels, aerospace solvents and aerospace hydraulic fluids. Any vehicular parts which may benefit from coating as defined herein may undergo coating, whether exposed to or hidden from view in normal use.

Household and office appliances, furniture items and tools as defined herein are appliances, furniture items and tools used in the home, including the garden, or in office environments. They may include fabric washers, dishwashers, dryers, refrigerators, stoves, microwave ovens, computer equipment and printers, air conditioning units, heat pump units, lawn and garden equipment including lawn furniture, hot tubs, lawnmowers, garden tools, hedge trimmers, string trimmers (strimmers), chainsaws, garden waster shedders, garden hand tools such as, for example, spades, forks, rakes and cutting tools, cupboards, desks, table, chairs, cabinets and other articles. Any parts of any such articles which may benefit from coating as defined herein may undergo coating; for example panels of appliances or furniture and handles of tools.

An industrial article, such as a powered industrial article, may include, for example, pumps, electricity generators, air compressors, industrial heat pumps and air conditioners, batteries and cement mixers. Any parts which benefit from coating as defined herein may undergo coating; for example panels and casings.

An electronics article, such as a consumer electronics article may be, for example, a computer, computer casing, television, cellphone, pager, camera, calculator, printer, scanner, digital decoder, clock, audio player, headphones or tablet; such as housings for computers, notebooks, smartphones, tablets, televisions, gaming equipment, computer equipment, computer accessories, MP3 players, and the like.

An architectural article may be, for example, a door, window, door frame, window frame, beam or support, or a panel, walling item or roofing item used in building construction, or a solar panel. The substrate of the architectural article may include, but are not limited to, architectural substrates, such as metallic or non-metallic substrates including: concrete, stucco, cement board, MDF (medium density fiberboard) and particle board, gypsum board, wood, stone, metal, plastics (e.g., vinyl siding and recycled plastics), wall paper, textile, plaster, fiberglass, ceramic, etc., which may be pre-primed by waterborne or solvent borne primers. The architectural substrate may be an interior wall (or other interior surface) of a building or residence. The architectural substrate may be an outdoor substrate exposed to outdoor conditions. The architectural substrate may be smooth or textured.

Articles protected by intumescent coatings may be metallic structures, for example steel structures, which are coating with an intumescent coating. The metallic structures may be load bearing parts of buildings. Unprotected steel will typically begin to soften at around 425° C. and lose approximately half of its strength by 650° C. Intumescent coatings are employed to retard the temperature increase of the steel, or other substrate. An intumescent coating may be improved by incorporation of the defined (co)polymer(A)-acrylic block copolymer into the matrix of the intumescent material prior to its coating onto a metallic substrate to be protected. The (co)polymer(A)-acrylic block copolymer may be present in an amount of at least 1 wt %, such as at least 2 wt %, for example at least 4 wt %, or at least 5%. The (co)polymer(A)-acrylic block copolymer may be present in an amount of up to 50 wt % by weight, such as up to 30 wt %, for example up to 25 wt %. These definitions refer to the weight of the (co)polymer(A)-acrylic block copolymer by weight of the admixed (co)polymer(A)-acrylic block copolymer/intumescent matrix material to be applied to a substrate.

“A structure” as used herein refers to any part of a building, bridge, transportation infrastructure, oil rig, oil platform, water tower, power line tower, support structures, wind turbines, walls, piers, docks, levees, dams, shipping containers, trailers, or any metal structure that is exposed to a corrosive environment.

Articles coated in accordance with the present disclosure may fall in two or more of the categories set out above. For example, computer equipment may be regarded as a household or as an office item, and as a consumer electronics item. A beam or support—an architectural item—may be coated with an intumescent material.

In the uses and articles defined above the coating composition is typically to coat surfaces and parts thereof (except for the use in an intumescent coating which is an admixture). A part may include multiple surfaces. A part may include a portion of a larger part, assembly, or apparatus. A portion of a part may be coated with the coating composition as defined herein or the entire part may be coated.

The coating compositions may be applied to at least a portion of the substrate. For example, when the coating compositions are applied to a food and/or beverage can, the coating compositions may be applied to at least a portion of an internal and/or external surface of said food and/or beverage can. For example, when the coating compositions are applied to a food and/or beverage can, the coating compositions may be applied to at least a portion of an internal surface of said food and/or beverage can.

The substrate may be new (i.e., newly constructed or fabricated) or it may be refurbished, such as, for example, in the case of refinishing or repairing a component of an automobile or aircraft.

The coating composition may be applied as a repair coating for component parts of food and beverage cans. For example, as a repair coating for a full aperture easy open end for food cans. This end component may repair coated, after fabrication, by airless spraying of the material on to the exterior of the score line. Other uses as repair coatings include the coating of seams and welds, such as side seams for which the coating may be applied to the area by spraying (airless or air driven) or roller coating. Repair coating can also include protection of vulnerable areas where corrosion may be likely due to damage, these areas include flanges, rims and bottom rims where the coating may be applied by spraying, roller coating flow or dip coating.

“Powder” and like terms, as used herein, refers to materials that are in the form of solid particulates, as opposed to materials which are in the liquid form.

The term “alk” or “alkyl”, as used herein unless otherwise defined, relates to saturated hydrocarbon radicals being straight, branched, cyclic or polycyclic moieties or combinations thereof and contain 1 to 20 carbon atoms, such as 1 to 10 carbon atoms, such as 1 to 8 carbon atoms, such as 1 to 6 carbon atoms, or even 1 to 4 carbon atoms. These radicals may be optionally substituted with a chloro, bromo, iodo, cyano, nitro, OR¹⁹, OC(O)R²⁰, C(O)R²¹, C(O)OR²², NR²³R²⁴, C(O)NR²⁵R²⁶, SR²⁷, C(O)SR²⁷, C(S) NR²⁵R²⁶, aryl or Het, wherein R¹⁹ to R²⁷ each independently represent hydrogen, aryl or alkyl, and/or be interrupted by oxygen or sulphur atoms, or by silano or dialkylsiloxane groups. Examples of such radicals may be independently selected from methyl, ethyl, n-propyl, isopropyl, n-butyl, isobutyl, sec-butyl, tert-butyl, 2-methylbutyl, pentyl, iso-amyl, hexyl, cyclohexyl, 3-methylpentyl, octyl and the like. The term “alkylene”, as used herein, relates to a bivalent radical alkyl group as defined above. For example, an alkyl group such as methyl which would be represented as —CH₃, becomes methylene, —CH₂—, when represented as an alkylene. Other alkylene groups should be understood accordingly.

The term “alkenyl”, as used herein, relates to hydrocarbon radicals having, such as up to 4, double bonds, being straight, branched, cyclic or polycyclic moieties or combinations thereof and containing from 2 to 18 carbon atoms, such as 2 to 10 carbon atoms, such as from 2 to 8 carbon atoms, such as 2 to 6 carbon atoms, or even 2 to 4 carbon atoms. These radicals may be optionally substituted with a hydroxyl, chloro, bromo, iodo, cyano, nitro, OR¹⁹, OC(O)R²⁰, C(O)R²¹, C(O)OR²², NR²³R²⁴, C(O)NR²⁵R²⁶, SR²⁷, C(O)SR²⁷, C(S) NR²⁵R²⁶, or aryl, wherein R¹⁹ to R²⁷ each independently represent hydrogen, aryl or alkyl, and/or be interrupted by oxygen or sulphur atoms, or by silano or dialkylsiloxane groups. Examples of such radicals may be independently selected from alkenyl groups include vinyl, allyl, isopropenyl, pentenyl, hexenyl, heptenyl, cyclopropenyl, cyclobutenyl, cyclopentenyl, cyclohexenyl, 1-propenyl, 2-butenyl, 2-methyl-2-butenyl, isoprenyl, farnesyl, geranyl, geranylgeranyl and the like. The term “alkenylene”, as used herein, relates to a bivalent radical alkenyl group as defined above. For example, an alkenyl group such as ethenyl which would be represented as —CH═CH2, becomes ethenylene, —CH═CH—, when represented as an alkenylene. Other alkenylene groups should be understood accordingly.

The term “alkynyl”, as used herein, relates to hydrocarbon radicals having, such as up to 4, triple bonds, being straight, branched, cyclic or polycyclic moieties or combinations thereof and having from 2 to 18 carbon atoms, such as 2 to 10 carbon atoms, such as from 2 to 8 carbon atoms, such as from 2 to 6 carbon atoms, or even from 2 to 4 carbon atoms. These radicals may be optionally substituted with a hydroxy, chloro, bromo, iodo, cyano, nitro, OR¹⁹, OC(O)R²⁰, C(O)R²¹, C(O)OR²², NR²³R²⁴, C(O)NR²⁵R²⁶, SR²⁷, C(O)SR²⁷, C(S) NR²⁵R²⁶, or aryl, wherein R¹⁹ to R²⁷ each independently represent hydrogen, aryl or lower alkyl, and/or be interrupted by oxygen or sulphur atoms, or by silano or dialkylsiloxane groups. Examples of such radicals may be independently selected from alkynyl radicals include ethynyl, propynyl, propargyl, butynyl, pentynyl, hexynyl and the like. The term “alkynylene”, as used herein, relates to a bivalent radical alkynyl group as defined above. For example, an alkynyl group such as ethynyl which would be represented as —C≡CH, becomes ethynylene, —C≡C—, when represented as an alkynylene. Other alkynylene groups should be understood accordingly.

The term “aryl” as used herein, relates to an organic radical derived from an aromatic hydrocarbon by removal of one hydrogen, and includes any monocyclic, bicyclic or polycyclic carbon ring of up to 7 members in each ring, wherein a ring is aromatic. These radicals may be optionally substituted with a hydroxy, chloro, bromo, iodo, cyano, nitro, OR¹⁹, OC(O)R²⁰, C(O)R²¹, C(O)OR²², NR²³R²⁴, C(O)NR²⁵R²⁶, SR²⁷, C(O)SR²⁷, C(S) NR²⁵R²⁶, or aryl, wherein R¹⁹ to R²⁷ each independently represent hydrogen, aryl or lower alkyl, and/or be interrupted by oxygen or sulphur atoms, or by silano or dialkylsilcon groups. Examples of such radicals may be independently selected from phenyl, p-tolyl, 4-methoxyphenyl, 4-(tert-butoxy)phenyl, 3-methyl-4-methoxyphenyl, 4-fluorophenyl, 4-chlorophenyl, 3-nitrophenyl, 3-aminophenyl, 3-acetamidophenyl, 4-acetamidophenyl, 2-methyl-3-acetamidophenyl, 2-methyl-3-aminophenyl, 3-methyl-4-aminophenyl, 2-amino-3-methylphenyl, 2,4-dimethyl-3-aminophenyl, 4-hydroxyphenyl, 3-methyl-4-hydroxyphenyl, 1-naphthyl, 2-naphthyl, 3-amino-1-naphthyl, 2-methyl-3-amino-1-naphthyl, 6-amino-2-naphthyl, 4,6-dimethoxy-2-naphthyl, tetrahydronaphthyl, indanyl, biphenyl, phenanthryl, anthryl or acenaphthyl and the like. The term “arylene”, as used herein, relates to a bivalent radical aryl group as defined above. For example, an aryl group such as phenyl which would be represented as -Ph, becomes phenylene, -Ph-, when represented as an arylene. Other arylene groups should be understood accordingly.

For the avoidance of doubt, the reference to alkyl, alkenyl, alkynyl, aryl or aralkyl in composite groups herein should be interpreted accordingly, for example the reference to alkyl in aminoalkyl or alk in alkoxyl should be interpreted as alk or alkyl above etc.

As used herein, unless otherwise expressly specified, all numbers such as those expressing values, ranges, amounts or percentages may be read as if prefaced by the word “about”, even if the term does not expressly appear. Also, the recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein. When ranges are given, any endpoints of those ranges and/or numbers within those ranges can be combined within the scope of the present disclosure.

Singular encompasses plural and vice versa. For example, although reference is made herein to “a” (co)polymer(A)-acrylic block copolymer, “a” (co)polymer(A), and the like, one or more of each of these and any other components can be used. As used herein, the term “polymer” refers to oligomers and both homopolymers and copolymers, and the prefix “poly” refers to two or more.

“Including” and like terms means “including but not limited to”. Similarly, as used herein, the terms “on”, “applied on/over”, “formed on/over”, “deposited on/over”, “overlay” and “provided on/over” mean formed, overlay, deposited, or provided on but not necessarily in contact with the surface. For example, a coating layer “formed over” a substrate does not preclude the presence of another coating layer of the same or different composition located between the formed coating layer and the substrate.”

The terms “comprising”, “comprises” and “comprised of” as used herein are synonymous with “including”, “includes” or “containing”, “contains”, and are inclusive or open-ended and do not exclude additional, non-recited members, elements or method steps. Additionally, although the present disclosure has been described in terms of “comprising”, the coating compositions detailed herein may also be described as “consisting essentially of” or “consisting of”. Although the present disclosure has been described in terms of “obtainable by”, the associated features of the present disclosure detailed herein may also be independently described as “obtained by”.

As used herein, the term “and/or,” when used in a list of two or more items, means that any one of the listed items can be employed by itself or any combination of two or more of the listed items can be employed. For example, if a list is described as comprising group A, B, and/or C, the list can comprise A alone; B alone; C alone; A and B in combination; A and C in combination, B and C in combination; or A, B, and C in combination.

Although the disclosure has been described in terms of ‘comprising’, ‘consisting essentially of’ or ‘consisting of’ are also within the scope of the present disclosure. For example, while the disclosure has been described in terms of a coating comprising a (co)polymer(A)-acrylic block copolymer, a coating consisting essentially of a (co)polymer(A)-acrylic block copolymer is also within the present scope. In this context, ‘consisting essentially of’ means that any additional coating components will not materially affect the enamel rating, hairing and/or solvent fraction of the coating.

Where ranges are provided in relation to a genus, each range may also apply additionally and independently to any one or more of the listed species of that genus.

All of the features contained herein may be combined with any of the above in any combination.

For a better understanding of the disclosure, and to show how the disclosure may be carried into effect, reference will now be made, by way of example, to the following experimental data.

### EXAMPLES

### Polyester-Acrylic Block Copolymer 1

Polyester-acrylic block copolymer 1 was prepared from the components of Table 1 as follows:

TABLE 1
polyester-acrylic block copolymer 1

| | |
|---|---|
| Ingredients | Parts by Weight |

Charge #1

| | |
|---|---|
| Cyclohexanone | 107.14 |
| Dynapol L914 polyester¹ | 250.00 |

Charge #2

| | |
|---|---|
| Methacrylic Anhydride | 1.20 |
| Triethylenediamine | 0.25 |

Charge #3

| | |
|---|---|
| Methacrylic Acid | 29.07 |
| Ethyl Methacrylate | 26.65 |
| Methyl Methacrylate | 26.65 |
| Hydroxyethyl Methacrylate | 14.53 |
| Dowanol DPM | 190.10 |

Charge #4

| | |
|---|---|
| tert-Butyl Perbenzoate | 8.61 |
| Dowanol DPM | 25.84 |

Charge #5

| | |
|---|---|
| Dowanol DPM | 19.38 |

Charge #6

| | |
|---|---|
| tert-Butyl Perbenzoate | 2.15 |
| Dowanol DPM | 6.46 |

Charge #7

| | |
|---|---|
| Dowanol DPM | 9.69 |

Charge #8

| | |
|---|---|
| Dimethylethanolamine | 30.79 |

Charge #9

| | |
|---|---|
| DI Water | 276.80 |

¹commerically available from Evonik

A three-liter round bottom, four-necked flask equipped with an agitator, a nitrogen inlet tube, a thermometer, and a reflux condenser was charged with the cyclohexanone of Charge #1. The flask was heated gradually to reflux at around 165° C., and the Dynapol L914 polyester of Charge #2 was slowly added during heat up to dissolve. Once the polyester pellets/beads were all dissolved, the temperature set point was reduced to 155° C. and Charge #2 was added, and the batch was held at 155° C. for 2 hours. In a separate vessel, a mixture of Charge #3 and #4 was prepared. At the end of the 2 hour hold, temperature was reduced further to 120° C. At 120° C., the mixture of Charge #3 and #4 was added to the flask at a steady rate over 2 hours through addition column. When completed, the batch was held at about 120° C. for 15 minutes, while Charge #5 was added to rinse addition column, and Charge #6 was prepared. After 15 minutes hold, 50% of Charge #6 was added and the batch was held for 30 minutes. When completed, the rest 50% of Charge #6 was added followed by Charge #7 solvent rinse and the batch was held for 1 hour. At the end of the 1 hour hold, heat was turned off and Charge #8 was added, followed by Charge #9. After Charge #9 was completed, a dispersion was formed. This batch yielded a polymer dispersion with 35% NV, Brookfield viscosity of 30,000 centipoise, and a number average molecular weight of 14,000.

### Polyester-Acrylic Block Copolymer 2

Polyester-acrylic block copolymer 2 was prepared from the components of Table 2 as follows:

TABLE 2
polyester-acrylic block copolymer 2

| | |
|---|---|
| Ingredients | Parts by Weight |

Charge #1

| | |
|---|---|
| Cyclohexanone | 107.14 |
| Vitel 2475¹ | 250.00 |

Charge #2

| | |
|---|---|
| Methacrylic Anhydride | 1.72 |
| Triethylenediamine | 0.25 |

Charge #3

| | |
|---|---|
| Methacrylic Acid | 7.89 |
| Styrene | 14.46 |
| Hydroxyethyl Methacrylate | 3.94 |
| Dowanol DPM | 159.37 |

Charge #4

| | |
|---|---|
| tert-Butyl Perbenzoate | 1.12 |
| Dowanol DPM | 3.36 |

Charge #5

| | |
|---|---|
| Dowanol DPM | 5.26 |

Charge #6

| | |
|---|---|
| tert-Butyl Perbenzoate | 0.56 |
| Dowanol DPM | 1.68 |

Charge #7

| | |
|---|---|
| Dowanol DPM | 2.63 |

Charge #8

| | |
|---|---|
| Dimethylethanolamine | 9.16 |

Charge #9

| | |
|---|---|
| DI Water | 208.37 |

¹commerically available from Bostik

A three-litre round bottom, four-necked flask equipped with an agitator, a nitrogen inlet tube, a thermometer, and a reflux condenser was charged with the cyclohexanone of Charge #1. The flask was heated gradually to reflux at around 165° C., and the Vitel 2475 of Charge #1 was slowly added during heat up to dissolve. Once the polyester pellets/beads were all dissolved, the temperature set point was reduced to 155° C. and Charge #2 was added, and the batch was held at 155° C. for 2 hours. In a separate vessel, a mixture of Charge #3 and #4 was prepared. At the end of the 2 hour hold, temperature was reduced further to 120° C. At 120° C., the mixture of Charge #3 and #4 was added to the flask at a steady rate over 2 hours through addition column. When completed, the batch was held at about 120° C. for 15 minutes, while Charge #5 was added to rinse addition column, and Charge #6 was prepared. After 15 minutes hold, 50% of Charge #6 was added and the batch was held for 30 minutes. When completed, the rest 50% of Charge #6 was added followed by Charge #7 solvent rinse and the batch was held for 1 hour. At the end of the 1 hour hold, heat was turned off and Charge #8 was added, followed by Charge #9. After Charge #9 was completed, a dispersion was formed. This batch yielded a polymer dispersion with 36% NV, Brookfield viscosity of 10,000 centipoise, and a number average molecular weight of 15,200.

### Polyester-Acrylic Block Copolymer 3

Polyester-acrylic block copolymer 3 was prepared from the components of Table 3 as follows:

TABLE 3
polyester-acrylic block copolymer 3

| | |
|---|---|
| Ingredients | Parts by Weight |

Charge #1

| | |
|---|---|
| Cyclohexanone | 107.14 |
| Skybon ES-660¹ | 250.00 |

Charge #2

| | |
|---|---|
| Methacrylic Anhydride | 1.37 |
| Triethylenediamine | 0.25 |

Charge #3

| | |
|---|---|
| Methacrylic Acid | 7.88 |
| Styrene | 14.44 |
| Hydroxyethyl Methacrylate | 3.94 |
| Dowanol DPM | 159.01 |

Charge #4

| | |
|---|---|
| tert-Butyl Perbenzoate | 1.12 |
| Dowanol DPM | 3.35 |

Charge #5

| | |
|---|---|
| Dowanol DPM | 5.25 |

Charge #6

| | |
|---|---|
| tert-Butyl Perbenzoate | 0.56 |
| Dowanol DPM | 1.68 |

Charge #7

| | |
|---|---|
| Dowanol DPM | 2.63 |

Charge #8

| | |
|---|---|
| Dimethylethanolamine | 8.95 |

Charge #9

| | |
|---|---|
| DI Water | 130.70 |

¹commerically available from SK Chemicals

A three-litre round bottom, four-necked flask equipped with an agitator, a nitrogen inlet tube, a thermometer, and a reflux condenser was charged with the cyclohexanone of Charge #1. The flask was heated gradually to reflux at around 165° C., and Charge #1.2 was slowly added during heat up to dissolve. Once the polyester pellets/beads were all dissolved, the temperature set point was reduced to 155° C. and Charge #2 was added and the batch was held at 155° C. for 2 hours. In a separate vessel, a mixture of Charge #3 and #4 was prepared. At the end of the 2 hour hold, temperature was reduced further to 120° C. At 120° C., the mixture of Charge #3 and #4 was added to the flask at a steady rate over 2 hours through addition column. When completed, the batch was held at about 120° C. for 15 minutes, while Charge #5 was added to rinse addition column, and Charge #6 was prepared. After 15 minutes hold, 50% of Charge #6 was added and the batch was held for 30 minutes. When completed, the rest 50% of Charge #6 was added followed by Charge #7 solvent rinse and the batch was held for 1 hour. At the end of the 1 hour hold, heat was turned off and Charge #8 was added, followed by Charge #9. After Charge #9 was completed, a dispersion was formed. This batch yielded a polymer dispersion with 40% NV, Brookfield viscosity of 2,000 centipoise, and a number average molecular weight of 15,300.

### Polyester and Acrylic Composition 1

Polyester and acrylic containing composition 1 was prepared from the components of Table 4 as follows:

TABLE 4
polyester and acrylic composition 1

| | |
|---|---|
| Ingredients | Parts by Weight |

Charge #1

| | |
|---|---|
| Cyclohexanone | 107.14 |
| Dynapol L914 polyester¹ | 250.00 |

Charge #2

| | |
|---|---|
| Methacrylic Acid | 29.07 |
| Ethyl Methacrylate | 26.65 |
| Methyl Methacrylate | 26.65 |
| Hydroxyethyl Methacrylate | 14.53 |
| Dowanol DPM | 190.10 |

Charge #3

| | |
|---|---|
| tert-Butyl Perbenzoate | 8.61 |
| Dowanol DPM | 25.84 |

Charge #4

| | |
|---|---|
| Dowanol DPM | 19.38 |

Charge #5

| | |
|---|---|
| tert-Butyl Perbenzoate | 2.15 |
| Dowanol DPM | 6.46 |

Charge #6

| | |
|---|---|
| Dowanol DPM | 9.69 |

Charge #7

| | |
|---|---|
| Dimethylethanolamine | 30.79 |

Charge #8

| | |
|---|---|
| DI Water | 276.80 |

¹commerically available from Evonik

A three-litre round bottom, four-necked flask equipped with an agitator, a nitrogen inlet tube, a thermometer, and a reflux condenser was charged with the cyclohexanone of Charge #1. The flask was heated gradually to reflux at around 165° C., and the Dynapol L914 polyester of Charge #1 was slowly added during heat up to dissolve. In a separate vessel, a mixture of Charge #2 and #3 was prepared. Once the polyester pellets/beads were all dissolved, the temperature was reduced to 120° C. At 120° C., the mixture of Charge #2 and #3 was added to the flask at a steady rate over 2 hours through addition column. When completed, the batch was held at about 120° C. for 15 minutes, while Charge #4 was added to rinse addition column, and Charge #5 was prepared. After 15 minutes hold, 50% of Charge #5 was added and the batch was held for 30 minutes. When completed, the rest 50% of Charge #5 was added followed by Charge #6 solvent rinse and the batch was held for 1 hour. At the end of the 1 hour hold, heat was turned off and Charge #7 was added, followed by Charge #8.

After Charge #8 was completed, a dispersion was not formed, and a phase-separated pasty material was formed instead.

### Polyester 1

Polyester 1 having the components of Table 5 was prepared according to the following method. All amounts in Table 5 are given in grams (g) unless otherwise specified.

TABLE 5
Components of Polyester 1

| | Component | Amount/g |
|---|---|---|
| 1 | 2-methyl-1,3-propanediol | 215.80 |
| 2 | Butyl titanate (catalyst) | 1.01 |
| 3 | 2,6-naphthalene dicarboxylic | 353.63 |
| | acid dimethyl ester | |
| 4 | Trimethylol propane | 4.63 |
| 5 | Isophthalic acid | 246.42 |
| 6 | 2-methyl-1,3-propanediol | 152.81 |
| 7 | Adipic acid | 132.88 |
| 8 | Maleic anhydride | 13.31 |
| 9 | Stannous octoate (catalyst) | 0.32 |
| 10 | SOLVESSO 100 * | 50.99 |
| 11 | SOLVESSO 100 | 592.77 |
| 12 | Dibasic ester 1 ** | 239.36 |
| 13 | Methyl ether propylene glycol | 263.22 |
| | acetate | |
| 14 | SOLVESSO 150 | 132.66 |

* commercially available from Exxon Mobile
** commercially available from Nexeo Solutions

Components 1-4 were added to a 3 L round-bottom flask equipped with a nitrogen blanket, temperature probe, vigreux column, column temperature probe and condenser. The flask was heated to perform a transesterification reaction and distill methanol while maintaining a column temperature of 65° C. and having a maximum batch temperature of 230° C. Once the distillation of methanol had finished, the flask was cooled to <150° C. Components 5-9 were added to the flask and the flask was heated to esterify and transesterify the reactants and distill water. The resin was processed up to 230° C. and maintained a distillation temperature of 96° C. Once the acid value of the resin was <15.00 mg KOH/g, the flask was cooled to <160° C. and component 10 was added. Then, the vigreux column and column temperature probe were replaced with a Dean-Stark filled with SOLVESSO 100 (commercially available from Exxon Mobile) in order to convert the distillation to an azeotropic distillation to remove the water that evolved as a by-product to the esterification reaction. The azeotropic distillation was continued until an acid value <2.00 mg KOH/g and a viscosity of W-Z was achieved (diluted to 40% TNV in cyclohexanone). The viscosity was measured in accordance with ASTM D1545-89 (‘Standard Test Method for Viscosity of Transparent Liquids by Bubble Time Method’). The resulting polyester material was then dissolved in components 11-14 to produce a resin that was about 42 percent by weight solids.

The glass transition temperature (Tg) of the resulting polyester material was 31° C.

### Polyester 2

Polyester 2 having the components of Table 6 was prepared according to the following method. All amounts in Table 6 are given in grams (g) unless otherwise specified.

TABLE 6
Components of Polyester 2

| | Component | Amount/g |
|---|---|---|
| 1 | 2-methyl-1,3-propanediol | 799.74 |
| 2 | Stannous octoate (catalyst) | 0.96 |
| 3 | Trimethylol propane | 120.99 |
| 4 | Phthalic anhydride | 293.43 |
| 5 | Isophthalic acid | 576.92 |
| 6 | Maleic anhydride | 335.29 |
| 7 | SOLVESSO 100 | 312.94 |
| 8 | 85% phosphoric acid | 44.71 |
| 9 | Deionised water | 16.32 |
| 10 | 2-butoxyethannol | 155.41 |
| 11 | Diethylene glycol monobutyl ether | 1343.30 |

Components 1-6 were added to a 5 L round-bottom flask equipped with a nitrogen blanket, temperature probe, vigreux column, column temperature probe, and condenser. The flask was heated to perform an esterification reaction and distill water while maintaining a column temperature of 96° C. and having a maximum batch temperature of 200° C. Once the distillation of water had finished and an acid value <13.00 mg KOH/g had been reached, the flask was cooled to <110° C. and components 7-9 were added to the flask. Then, the vigreux column and column temperature probe were replaced with a Dean-Stark filled with SOLVESSO 100. An azeotropic distillation was performed until a viscosity of U-W was achieved (diluted to 50% TNV using a 10:1 monobutyl ether of diethylene glycol: 2-butoxyethanol solution). The viscosity was measured in accordance with ASTM D1545-89 (‘Standard Test Method for Viscosity of Transparent Liquids by Bubble Time Method’). The resulting phosphatized polyester material was then dissolved in components 10 and 11 to produce a resin which was about 50 percent by weight solids.

The glass transition temperature (Tg) of the resulting polyester material was −5° C.

### Polyester-Acrylic Graft Copolymer 1

Polyester intermediate 1 having the components of Table 7 was prepared according to the following method. All amounts in Table 7 are given in grams (g) unless otherwise specified.

TABLE 7
Components of Polyester Intermediate 1

| | Component | Amount/g |
|---|---|---|
| 1 | 2-methyl-1,3-propanediol | 152.38 |
| 2 | 1,4-Cyclohexanedimethanol | 577.77 |
| 3 | Terephthalic Acid | 261.90 |
| 4 | Tetrabutyl Titanate (catalyst) | 0.7936 |
| 5 | Stannous octoate (catalyst) | 0.7936 |
| 6 | Isophthalic acid | 477.77 |
| 7 | 1,4-Cyclohexanedicarboxylic Acid | 90.47 |
| 8 | Maleic anhydride | 26.98 |
| 9 | SOLVESSO 100 | 199.90 |
| 10 | Dowanol DPM | 599.40 |
| 11 | SOLVESSO 100 | 447.34 |

Components 1-5 were added to a 3 L round-bottom flask equipped with a nitrogen blanket, temperature probe, vigreux column, column temperature probe and condenser. The flask was heated to perform a esterification reaction and distill water while maintaining a column temperature of 96° C. and having a maximum batch temperature of 230° C. Once the column temperature was dropped to <40° C., the flask was cooled to <150° C. Components 6-8 were added to the flask and the flask was heated to esterify the reactants and continue to distill water. The resin was processed up to 200° C. and maintained a distillation temperature of 96° C. Once the acid value of the resin was <15.00 mg KOH/g, the flask was cooled to <160° C. and component 9 was added. Then, the vigreux column and column temperature probe were replaced with a Dean-Stark filled with SOLVESSO 100 (commercially available from Exxon Mobile) in order to convert the distillation to an azeotropic distillation to remove the water that evolved as a by-product to the esterification reaction. The azeotropic distillation was continued until an acid value <5.00 mg KOH/g and a viscosity of Z1-Z2 was achieved (diluted to 50% TNV in cyclohexanone). The viscosity was measured in accordance with ASTM D1545-89 (‘Standard Test Method for Viscosity of Transparent Liquids by Bubble Time Method’). The resulting polyester material was then dissolved in components 10-11 to produce a resin which was about 52 percent by weight solids, and number average molecular weight of 4,900.

Polyester-acrylic graft copolymer 1 (backbone grafting) having the components of Table 8 was then prepared according to the following method.

TABLE 8
Polyester-acrylic graft copolymer 1

| | |
|---|---|
| Ingredients | Parts by Weight |

Charge #1

| | |
|---|---|
| Polyester Intermediate 1 | 338.92 |
| Dowanol DPM | 5.68 |

Charge #2

| | |
|---|---|
| Methacrylic Acid | 11.00 |
| Ethyl Methacrylate | 10.08 |
| Methyl Methacrylate | 10.08 |
| Hydroxyethyl Methacrylate | 5.50 |

Charge #3

| | |
|---|---|
| tert-Butyl Peracetate (50% in mineral spirits) | 4.96 |
| Dowanol DPM | 18.37 |

Charge #4

| | |
|---|---|
| Polyester Intermediate | 338.92 |
| Dowanol DPM | 5.68 |

Charge #5

| | |
|---|---|
| Methacrylic Acid | 11.00 |
| Ethyl Methacrylate | 10.08 |
| Methyl Methacrylate | 10.08 |
| Hydroxyethyl Methacrylate | 5.50 |

Charge #6

| | |
|---|---|
| tert-Butyl Peracetate (50% in mineral spirits) | 4.96 |
| Dowanol DPM | 18.37 |

Charge #7

| | |
|---|---|
| Dowanol DPM | 6.71 |

Charge #8

| | |
|---|---|
| tert-Butyl Peracetate (50% in mineral spirits) | 1.70 |
| Dowanol DPM | 6.28 |

Charge #9

| | |
|---|---|
| tert-Butyl Peracetate (50% in mineral spirits) | 1.70 |
| Dowanol DPM | 6.28 |

Charge #10

| | |
|---|---|
| Dowanol DPM | 6.71 |

Charge #11

| | |
|---|---|
| Dimethylethanolamine | 14.81 |

Charge #12

| | |
|---|---|
| DI Water | 242.69 |

A three-litre round bottom, four-necked flask equipped with an agitator, a nitrogen inlet tube, a thermometer, and a reflux condenser was charged Charge #1. The flask was heated gradually to 130° C., while in a separate vessel, a mixture of Charge #2 and #3 was prepared. At 130° C., mixture of Charge #2 and #3 was added to the flask at a steady rate over 1 hours through addition column. In a separate vessel, a mixture of Charge #5 and #6 was prepared. Once Charge #2 and #3 were all in, Charge #4 was added, and the temperature was allowed to resume to 130° C. Once at 130° C., the mixture of Charge #5 and #6 was added to the flask at a steady rate over 1 hours through addition column. When completed, Charge #7 was added to rinse addition column, followed by Charge #8 and 30 minutes hold. Then Charge #9 was added followed by Charge #10 and another 30 minutes hold. At the end of the 30 minutes hold, heat was turned off and Charge #11 was added, followed by Charge #12. After Charge #12 was completed, a dispersion was formed. This batch yielded a polymer dispersion with 40% NV, Brookfield viscosity of 536 centipoise, number average molecular weight of 4,900, and mean particle size value of 0.157 micrometer.

### Comparative Coating Composition 1

Polyesters 1 and 2 were formed into comparative coating composition 1 with the components as shown in Table 9.

TABLE 9
Formulation of comparative coating composition 1

| | |
|---|---|
| Polyester component 1 | 61.34 |
| Polyester component 2 | 2.60 |
| ProHere L 90700 ¹ | 1.48 |
| 2-butoxyethyl acetate | 7.25 |
| Maprenal BF 892/68B ² | 7.63 |
| Lanco TF1780 EF ³ | 0.06 |
| SOLVESSO 100 ⁴ | 3.15 |
| Dynoadd F-300 ⁵ | 0.07 |
| SOLVESSO 150 ⁴ | 16.43 |
| | 100.00 |
| Solids | 31.34 |

¹ Carnauba wax dispersion commercially available from Michelman, Inc.
² methylol type, highly reactive n-butylated benzoguanamine-formaldehyde resin commercially available from Ineos
³ PTFE-modified polyethylene wax commercially available from Lubrizol Advanced Materials, Inc.
⁴ Commercially available from Exxon Mobil
⁵ Additive commercially available from Dynea

### Inventive Coating Compositions 1-3 and Comparative Coating Composition 2

Polyester-acrylic block copolymer resins 1-3 were formed into inventive coating compositions 1-6, and polyester-acrylic graft copolymer resin 1 into comparative coating composition 2 with the components as shown in Table 10.

TABLE 10
Coating compositions

| | | | | | | | Comp. |
|---|---|---|---|---|---|---|---|
| | Ex. 1 | Ex. 2 | Ex. 3 | Ex. 4 | Ex. 5 | Ex. 6 | Ex. 2 |
| Polyester-acrylic block | 76.41 | 78.99 | | | | | |
| copolymer 1 | | | | | | | |
| Polyester-acrylic block | | | 105.34 | 94.53 | 93.06 | | |
| copolymer 2 | | | | | | | |
| Polyester-acrylic block | | | | | | 84.01 | |
| copolymer 3 | | | | | | | |
| Polyester-acrylic graft | | | | | | | 74.75 |
| copolymer 1 | | | | | | | |
| Cymel 1123¹ | 3.00 | 1.50 | | 3.80 | 3.80 | 3.80 | 5.00 |
| HRJ-13078² | | 0.80 | | | | 1.01 | |
| Nacure 5925 (DDBSA)³ | 0.12 | 0.12 | | 0.29 | 0.29 | 0.29 | 0.13 |
| Lanco Glidd 5462⁴ | | | | | 1.90 | | |
| MPP-61AL in BC⁵ | | | | | 0.95 | | |
| BYK-333⁶ | 0.08 | 0.08 | 0.08 | 0.08 | | 0.08 | 0.08 |
| Orgaosol 2001 | 0.15 | 0.15 | | | | | |
| DI Water | | | | 1.31 | | 10.81 | |
| Triethylene glycol | 20.24 | 18.37 | | | | | 20.04 |
| | 100 | 100 | 105 | 100 | 100 | 100 | 100 |

¹highly methylated/ethylated benzoguanamine resin—commercially available from Allnex;
²phenol formaldehyde resin—commercially available from SI Group;
³catalyst—commercially available from king industries;
⁴wax—commercially available from Lubrizol;
⁵wax—commercially available from Micro powders;
⁶surfactant and a wetting agent—commercially available from BYK

### Testing Methods

Test panel preparation: The coatings were drawn down with a wire wound bar over zirconium-treated aluminium (0.0082 inch) to give a dry film weight of 6.5-7.5 milligrams/square inch (msi). The panels were then baked in a three zone coil oven (249/326/293° C.) to a peak metal temperature of 240° C. The coated panels were stamped and scored into easy open ends (EOEs) of the CDL-type.

Venting/Eversion testing: Eversion testing was used to determine the degree of venting. The contents of a 12 ounce (340 g) can of soda which had been cooled to 1.5° C. overnight was gently transferred into an empty 12 ounce (340 g) beverage can. A CDL seamer was then used to seam the can ends onto the body of the can. The cans were placed upside down (i.e. with the can end being tested being at the bottom) in an incubator and incubated at 38° C. for 18 hours. After this time, the cans were removed from the incubator and transferred to a fume hood. A can opener or screwdriver was then used to gently leverage the pull tab of the can end. If a metal crack sound was heard (rupture of the score line) with the pressure release ‘hiss’, there was no eversion and sufficient venting has occurred. This was considered to be a pass. If a metal crack sound was heard (rupture of the score line) but the pressure was not released, there was eversion and sufficient venting had not occurred. This was considered to be a failure. The test was repeated a number of times and the number of failures was recorded. For example, 2 failures out of 16 test repeats would be recorded as 2/16.

L-85 pack: As reported herein, the enamel rating after pack was measured as follows: 47 grams of the stock solution of L-85 was added to the can followed by the addition of 308 grams of carbonated water. A 202 type seamer was then used to seam an end onto the can. The can was then placed upside down (inverted) into a 100° F. (38° C.) incubator for 10 days. The can was then removed from the incubator, opened, and then measured using the Waco Enamel Rater test in which electrolyte was added to the plastic cup of Waco Enamel Rater, the can end was fitted onto the beveled end of the cup, and a vacuum applied to hold the end securely on the cup. When the cup was inverted, the electrode and can end were immersed in the electrolyte and the reading was displayed on the Enamel Rater.

Liquor 85 Test Pack (L-85) stock solution: Deionized Water 917.3 grams; Citric Acid 92.0 grams; 85% Phosphoric Acid 33.3 grams; Morton Salt (Sodium Chloride) with no iodine 71.0 grams.

Solvent Fraction: A cured film formed from the coating composition of the present disclosure may have a solvent fraction of ≤16%, such as ≤12% or ≤5%.

As reported herein, the solvent fraction was measured as follows: A four square inch disk was punched out in a hold puncher. The disk was then weighed on a four place balance. This was the “initial weight”. A sample was then placed into a rack and soaked in MEK (methyl ethyl ketone) for 10 minutes. Next, the sample was removed and placed into a 400° F. oven for 2 minutes, removed from the oven, cooled, and weighed again. This value was the “post bake weight”. Next, the disk was placed into Sulfuric Acid (A298-212 Technical Grade available from Fisher Scientific) for 3 minutes to strip the coating from the metal. The panel was rinsed with water to remove the coating completely. Then the panel was dried and re-weighed. This was the “final weight”. The equation used to determine Solvent Fraction was:

(Initial weight−Post Bake weight)/(Initial weight−Final weight)×100=Solvent Fraction

Blush Resistance: Blush resistance measures the ability of a coating to resist attack by various testing solutions. When the coated film absorbs test solution, it generally becomes cloudy or looks white. Blush is measured visually using a scale of 1-10 where a rating of “10” indicates no blush and a rating of “1” indicates complete whitening of the film. Blush ratings of at least 7 are typically desired for commercially viable coatings. The coated panel tested is 2×4 inches (5×10 cm) and the testing solution covers half of the panel being tested so you can compare blush of the exposed panel to the unexposed portion.

Adhesion: Adhesion testing is performed to assess whether the coating adheres to the substrate. The adhesion test is performed according to ASTM D 3359-Test Method B, using Scotch 610 tape, available from 3M Company of Saint Paul, Minn. Adhesion is generally rated on a scale of 0-10 where a rating of “10” indicates no adhesion failure, a rating of “9” indicates 90% of the coating remains adhered, a rating of “8” indicates 80% of the coating remains adhered, and so on.

Dowfax Detergent Test: The “Dowfax” test is designed to measure the resistance of a coating to a boiling detergent solution. The solution is prepared by mixing 5 grams of DOWFAX 2A1 (product of Dow Chemical) into 3000 grams of deionized water. Coated strips are immersed into the boiling Dowfax solution for 15 minutes. The strips are then rinsed and cooled in deionized water, dried, and immediately rated for blush as described previously.

Joy Detergent Test: The “Joy” test is designed to measure the resistance of a coating to a hot 180° F. (82° C.) Joy detergent solution. The solution is prepared by mixing 30 grams of Ultra Joy Dishwashing Liquid (product of Procter & Gamble) into 3000 grams of deionized water. Coated strips are immersed into the 180° F. (82° C.) Joy solution for 15 minutes. The strips are then rinsed and cooled in deionized water, dried, and immediately rated for blush as described previously.

Hairing: Hairing is a defect of coating fibers built up during coil stamping. Depending on the severity of built up, 5 levels of grade of hairing were used to measure the hairing at the shell punch stage: 1 means no hairing, 2 means slight hairing, 3 means moderate hairing, 4 means heavy hairing, 5 means severe hairing.

TABLE 11
Coating performance

| Applied on A272, | | | Average Initial | APU of 10 |
|---|---|---|---|---|
| Cr6, PMT465F/10″ | | | ERV (6 | Days L-85, |
| Example | MSI | Hairing | replicates), mA | ppm |
| Comparative | 7.1 | 3 | 0.10 | 0.78 |
| Example 1 | | | | |
| Comparative | 7.1 | 5 | 0.21 | 1.53 |
| Example 2 | | | | |
| Example 1 | 7.8 | 4 | 1.65 | — |
| Example 2 | 7.2 | 4 | 1.20 | — |
| Example 3 | 8.2 | 3 | — | — |
| Example 4 | 8.3 | 2 | 0.07 | 0.906 |
| Example 5 | 7.6 | 3 | 0.10 | 0.647 |
| Example 6 | 6.7 | 3 | 0.05 | 0.84 |

TABLE 12
Coating performance

| | | | | 1% Joy | | 0.165% Dowfax | |
|---|---|---|---|---|---|---|---|
| | | | | 10 @ 180 F. | | 15′ @ Boil | |
| Example | MSI | Sol. Frac. % | COF | Blush | % Adh. | Blush | % Adh. |
| Comparative Example 1 | 7 | 4.8 | 0.050 | 8 | 100 | 7 | 100 |
| Comparative Example 2 | 8.1 | 2.3 | 0.055 | 8 | 100 | 6 | 100 |
| Example 1 | 7.8 | 1.8 | 0.055 | 8 | 100 | 6 | 100 |
| Example 2 | 7.2 | 1.7 | 0.055 | 8 | 100 | 7 | 100 |
| Example 3 | 8.2 | 13.2 | 0.045 | 7 | 98 | 5 | 99 |
| Example 4 | 8.3 | 0.0 | 0.045 | 9 | 100 | 8 | 100 |
| Example 5 | 7.6 | 0.0 | 0.065 | 9 | 100 | 7 | 100 |
| Example 6 | 6.7 | 2.1 | 0.055 | 7 | 100 | 7 | 100 |

TABLE 13
Venting performance

| | Test 1 | Test 2 |
|---|---|---|
| Comparative Example 1 | 5/6 | 4/6 |
| Example 5 | 0/12 | 0/18 |

### Polyester-Acrylic Block Copolymer 4

Polyester-acrylic block copolymer 4 was prepared from the components of Table 14 as follows:

TABLE 14
polyester-acrylic block copolymer 4

| | |
|---|---|
| Ingredients | Parts by Weight |

Charge #1

| | |
|---|---|
| Dynapol L912 polyester¹ | 265.22 |
| Aromatic 100 | 151.56 |
| Dowanol DPM | 265.22 |

Charge #2

| | |
|---|---|
| Glycidyl methacrylate | 2.69 |
| Ethyl triphenyl phosphonium iodide | 0.06 |

Charge #3

| | |
|---|---|
| Methacrylic acid | 38.73 |
| Styrene | 19.40 |
| Ethyl acrylate | 41.40 |
| Hydroxyethyl Methacrylate | 11.00 |
| Dowanol DPM | 20.00 |
| Di-Benzoyl peroxide (75%) | 10.60 |
| Dowanol DPM | 15.00 |

Charge #4

| | |
|---|---|
| Tert.Butyl peroctoate | 2.40 |
| Dowanol DPM | 10.00 |

Charge #5

| | |
|---|---|
| Dimethyl Ethanol amine | 26.08 |

Charge #6

| | |
|---|---|
| Deionized water | 330.00 |

¹commerically available from Evonik

A three-litre round bottom, four-necked flask equipped with an agitator, a nitrogen inlet tube, a thermometer, and a reflux condenser, was charged with the Charge #1. The flask was heated gradually to around 150° C., and batch was held until the Dynapol L912 polyester was dissolved. In a separate vessel, a mixture of Charge #2 was prepared. Once the polyester pellets/beads were all dissolved, Charge #2 was added, and batch was held for 4 hours at 150° C. After the 4-hr hold, the temperature was reduced to 125° C. At 125° C., the mixture of Charge #3 was added to the flask at a steady rate over 2 hours through addition column. When completed, the batch was held at about 125° C. for 15 minutes. After 15 minutes hold, 50% of Charge #4 was added and the batch was held for 60 minutes. When completed, the rest 50% of Charge #4 was added and the batch was held for 1 hour. At the end of the 1-hour hold, heat was turned off and cooled to 90° C. Once the reached around 90° C., Charge #5 was added with good agitation followed by addition of Charge #6. Heat was turned off and a stable polymer dispersion was formed. This batch yielded a water base polymer dispersion with 32.1% NV, Brookfield viscosity of 918.8 centipoise/spindle #6/100 rpm. The dispersion had a number average molecular weight (Mn) of 6,867 Da and an acid value of 0.58 mg KOH/g.

### Polyester-Acrylic Block Copolymer 5

Polyester-acrylic block copolymer 5 was prepared from the components of Table 15 as follows:

TABLE 15
polyester-acrylic block copolymer 5

| | |
|---|---|
| Ingredients | Parts by Weight |

Charge #1

| | |
|---|---|
| Dynapol L912 polyester¹ | 265.22 |
| Aromatic 100 | 151.56 |
| Dowanol DPM | 265.22 |

Charge #2

| | |
|---|---|
| Glycidyl methacrylate | 2.69 |
| Ethyl triphenyl phosphonium iodide | 0.06 |

Charge #3

| | |
|---|---|
| Methacrylic acid (MAA) | 38.73 |
| Styrene | 19.40 |
| Ethyl acrylate (EA) | 41.40 |
| HEMA | 11.00 |
| N-Butoxymethyl Acrylamide | 16.40 |
| Dowanol DPM | 20.00 |
| Di-Benzoyl peroxide (75%) | 10.60 |
| Dowanol DPM | 15.00 |

Charge #4

| | |
|---|---|
| Tert.Butyl peroctoate | 2.40 |
| Dowanol DPM | 10.00 |

Charge #5

| | |
|---|---|
| Dimethyl Ethanol amine | 26.08 |

Charge #6

| | |
|---|---|
| Deionized water | 330.00 |

¹commerically available from Evonik

A three-litre round bottom, four-necked flask equipped with an agitator, a nitrogen inlet tube, a thermometer, and a reflux condenser, was charged with the Charge #1. The flask was heated gradually to around 150° C., and the batch was held until the Dynapol L912 polyester was dissolved. In a separate vessel, a mixture of Charge #2 was prepared. Once the polyester pellets/beads were all dissolved, Charge #2 was added, and the batch was held for 4 hours at 150° C. After the 4 hour hold, the temperature was reduced to 125° C. At 125° C., the mixture of Charge #3 was added to the flask at a steady rate over 2 hours through an addition column. When completed, the batch was held at about 125° C. for 15 minutes. After 15 minutes hold, 50% of Charge #4 was added and the batch was held for 60 minutes. When completed, the other 50% of Charge #4 was added and the batch was held for 1 hour. At the end of the 1 hour hold, heat was turned off and cooled to 90° C. Once the reached around 90° C., Charge #5 was added with good agitation followed by addition of Charge #6. Heat was turned off and a stable polymer dispersion was formed. This batch yielded a waterbase polymer dispersion with 29.7% NV, and Brookfield viscosity of 718.7 centipoise/spindle #6/100 rpm. The dispersion had a number average molecular weight (Mn) of 6,834 Da, and an acid value of 0.58 mg KOH/g.

### Polyester and Acrylic Composition 2

Polyester and acrylic containing composition 2 was prepared from the components of Table 16 as follows:

TABLE 16
polyester-acrylic 2

| | |
|---|---|
| Ingredients | Parts by Weight |

Charge #1

| | |
|---|---|
| Dynapol L914 polyester¹ | 265.22 |
| Aromatic 100 | 151.56 |
| Dowanol DPM | 265.22 |

Charge #2

| | |
|---|---|
| MAA | 38.73 |
| Styrene | 19.40 |
| EA | 41.40 |
| HEMA | 11.00 |
| Dowanol DPM | 20.00 |
| Tert.Butylperacetate (50% solids) | 8.67 |
| Dowanol DPM | 15.00 |

Charge #3

| | |
|---|---|
| Tert.Butyl peroctoate | 2.40 |
| Dowanol DPM | 10.00 |

Charge #4

| | |
|---|---|
| Dimethyl Ethanol amine | 26.08 |

Charge #5

| | |
|---|---|
| Deionized water | 330.00 |

¹commerically available from Evonik

A three-litre round bottom, four-necked flask equipped with an agitator, a nitrogen inlet tube, a thermometer, and a reflux condenser, was charged with the Charge #1. The flask was heated gradually to around 150° C., and the batch was held until the Dynapol L914 polyester was dissolved. In a separate vessel, a mixture of Charge #2 was prepared. Once the polyester pellets/beads were dissolved, the temperature was reduced to 125° C. At 125° C., the mixture of Charge #2 was added to the flask at a steady rate over 2 hours through an addition column. When completed, the batch was held at about 125° C. for 15 minutes. After 15 minutes hold, 50% of Charge #3 was added and the batch was held for 60 minutes. When completed, the other 50% of Charge #3 was added and the batch was held for 1 hour. At the end of the 1 hour hold, heat was turned off and cooled to 90° C. Once the batch temperature reached around 90° C., Charge #4 was added with good agitation followed by addition of Charge #5. Heat was turned off and a stable polymer dispersion was not formed. The mixture had phase separation instead with pasty materials formed.

### Polyester-Acrylic Graft Copolymer 2

Polyester Intermediate 2 having the components of Table 17 was prepared according to the following method. All amounts in Table 17 are given in grams (g) unless otherwise specified.

TABLE 17
Components of polyester intermediate 2

| | Component | Amount/g |
|---|---|---|
| 1 | 2-methyl-1,3-propanediol | 370.00 |
| 2 | Butyl titanate (catalyst) | 0.7534 |
| 3 | 2,6-naphthalene dicarboxylic | 990.59 |
| | acid dimethyl ester | |
| 4 | Trimethylol propane | 16.20 |
| 5 | Cyclohexanedimethanol | 65.00 |
| 6 | Butyl ethyl propanediol | 65.00 |
| 7 | Tetrabutyl Titanate/Stannous | 0.8084 |
| | Octoate | |
| 8 | Terephthalic acid | 132.88 |
| 9 | Maleic anhydride | 25.00 |
| 10 | Methyl Hydroquinone | 0.49 |
| 11 | Stannous octoate (catalyst) | 0.8084 |
| 12 | SOLVESSO 100* | 121.41 |
| 13 | Dowanol DPM | 769.25 |

*Commercially available from Exxon Mobile

Components 1-6 were added to a 3 L round-bottom flask equipped with a nitrogen blanket, temperature probe, Vigreux column, column temperature probe, and condenser. The flask was heated to perform a transesterification reaction and distill methanol while maintaining a column temperature of 65° C. and having a maximum batch temperature of 230° C. Once the distillation of methanol had finished, the flask was cooled to <150° C. Components 7-11 were added to the flask and the flask was heated to esterify and transesterify the reactants and distill water. The resin was processed up to 230° C. and maintained a distillation temperature of 96° C. Once cut viscosity of 50% resin in Cyclohexanone is Z2, the flask was cooled to <160° C. and component 12 was added slowly. Then, the Vigreux column and column temperature probe were replaced with a Dean-Stark filled with SOLVESSO 100 (commercially available from Exxon Mobile) in order to convert the distillation to an azeotropic distillation to remove the water that evolved as a by-product to the esterification reaction. The azeotropic distillation was continued until a viscosity of Z6-Z7 was achieved (diluted to 50% TNV in cyclohexanone). The viscosity was measured in accordance with ASTM D1545-89 (‘Standard Test Method for Viscosity of Transparent Liquids by Bubble Time Method’). The resulting polyester material was then dissolved in component 13 to produce a resin that was about 60 percent by weight solids.

Polyester-acrylic graft copolymer 2 having the components of Table 18 was then prepared according to the following method.

TABLE 18
Polyester-acrylic graft copolymer 2

| | |
|---|---|
| Ingredients | Parts by Weight |

Charge #1

| | |
|---|---|
| Polyester Intermediate 2 | 597.41 |
| Dowanol DPM | 11.35 |

Charge #2

| | |
|---|---|
| Methacrylic Acid | 22.00 |
| Ethyl Methacrylate | 20.17 |
| Methyl Methacrylate | 20.17 |
| Hydroxyethyl Methacrylate | 11.00 |

Charge #3

| | |
|---|---|
| tert-Butyl Peracetate (50% in mineral spirits) | 9.92 |
| Dowanol DPM | 36.74 |

Charge #4

| | |
|---|---|
| Dowanol DPM | 6.71 |

Charge #5

| | |
|---|---|
| tert-Butyl Peracetate (50% in mineral spirits) | 1.70 |
| Dowanol DPM | 6.28 |

Charge #6

| | |
|---|---|
| tert-Butyl Peracetate (50% in mineral spirits) | 1.70 |
| Dowanol DPM | 6.28 |

Charge #7

| | |
|---|---|
| Dowanol DPM | 6.71 |

Charge #8

| | |
|---|---|
| Dimethylethanolamine | 41.39 |

Charge #9

| | |
|---|---|
| DI Water | 315.16 |

A three-litre round bottom, four-necked flask equipped with an agitator, a nitrogen inlet tube, a thermometer, and a reflux condenser were charged Charge #1. The flask was heated gradually to 130° C., while in a separate vessel, a mixture of Charge #2 and #3 was prepared. At 130° C., the mixture of Charge #2 and #3 was added to the flask at a steady rate over 2 hours through an addition column. In a separate vessel, a mixture of Charge #5 and #6 was prepared. Once Charge #2 and #3 were all in, Charge #4 was added, and the temperature was allowed to resume to 130° C. Once at 130° C., the Charge #5 was added over 5 minutes and was held for 30 minutes. After the hold was done, Charge #6 was added to the flask over 5 minutes and was held for 30 minutes. When completed, Charge #7 was added to rinse the addition column, and the batch was cooled to <100° C. Once the batch temperature reached <100° C., Charge #8 was added followed by Charge #9 over 20 minutes at 90° C. After Charge #9 was completed, a dispersion was formed. This batch yielded a polymer dispersion with 34% NV, Brookfield viscosity of 549 centipoise and a number average molecular weight of 3, 728 Da.

### Inventive Coating Compositions 7-8 and Comparative Coating Composition 3

Polyester-acrylic block copolymer resins 4-5 were formed into inventive coating compositions 7-8, and polyester-acrylic graft copolymer resin 2 into comparative coating composition 3 with the components as shown in Table 19.

TABLE 19
Coating compositions

| | Example | Example | Comp. |
|---|---|---|---|
| | 7 | 8 | Example 3 |
| Polyester-acrylic block copolymer 4 | 61.70 | | |
| Polyester-acrylic block copolymer 5 | | 64.70 | |
| Polyester-acrylic graft copolymer 2 | | | 55.89 |
| HRJ-13078¹ | 1.50 | 2.20 | 2.00 |
| Dowanol DPM | | 33.00 | 42.11 |
| DI Water | 34.20 | | |
| Amyl Alcohol | 2.50 | | |
| | 100.00 | 100.00 | 100.00 |

¹Phenol formaldehyde resin - commercially available from SI Group

### Testing Methods

Test panel preparation: The coatings were drawn down with a wire wound bar over zirconium-treated aluminium panel 380 F/3′ (0.00065 inch) to give a dry film weight of 1.8 to 2.3 milligrams/square inch (msi). The panels were then baked at 193° C. for 3 minutes.

MEK Double Rubs: The coated substrate was manually rubbed in a back and forth motion using a clean cheesecloth soaked in methyl ethyl ketone attached to 2 lbs hammer. The number of double rubs (back and forth motion) that the coating survives prior to failure was recorded. Failure occurs when the coating was broken through to reveal the underlying substrate. The results are shown in Table 20.

Wedge bend Test for flexibility: Mandrel bend (sometimes referred to as wedge bend) according to ASTM Method D 522-93. Coated panels were cut into 1.5×4 inch plaques for wedge bend testing. Coatings were evaluated for flex by how much % spotty failure was seen along the bent radius after soaking the panels for one minute in 10% aqueous copper sulfate solution after wedge bending them. The results are shown in Table 20.

Blush Resistance: Blush resistance was used to measure the ability of a coating to resist attack by various testing solutions. When the coated film absorbs test solution, it generally becomes cloudy or looks white. Blush was measured visually using a scale of 1-10 where a rating of “10” indicates no blush and a rating of “1” indicates complete whitening of the film. Blush ratings of at least 7 are typically desired for commercially viable coatings. The coated panel tested was 2×4 inches (5×10 cm) and the testing solution covered half of the panel being tested.

Blistering Resistance: Blistering resistance was used to measure the ability of a coating to resist attack by various testing solutions. When a coated film absorbs test solution, it can become roughened and can lose adhesion to the substrate. Blistering was measured visually using a scale of 0-5 where a rating of “5” indicates no blistering and a rating of “0” indicates delamination from the substrate. Blistering ratings of at least 4 are typically desired for commercially viable coatings. The coated panel tested was 2×4 inches (5×10 cm) and the testing solution covered half of the panel being tested.

Acetic Acid Tests: The “Acetic Acid” test was designed to measure the resistance of a coating to a boiling 3% acetic acid solution. A 3% stock solution was prepared by mixing 99 grams of Glacial Acetic Acid (product of Fisher Scientific) into 3201 grams of deionized water. Coated strips were immersed into the boiling Acetic Acid solution for 30 minutes. The strips were then rinsed in deionized water, dried, and immediately rated for blister performance as described previously. The results are shown in Table 21.

Hard to Hold stimulant solutions: Coated panels were cut into 2×4 inch Test panels and were soaked in two different stimulant acid solutions for 10 days at 49° C. Test panels were rated for blush resistance and blister resistance as described above. The results are shown in Table 21.

TABLE 20
Coating performance

| | | Number of MEK | Wedge bend in |
|---|---|---|---|
| Example | MSI | double rubs | mm (% failure) |
| Comparative Example 3 | 2.38 | 9 | 78 |
| Example 7 | 1.98 | — | 57 |
| Example 8 | 2.10 | 30 | 16 |

TABLE 21
Coating performance

| | | | 0.01% Orange | | | |
|---|---|---|---|---|---|---|
| | | 3% | Oil/1% Lactic | | 0.25% Formic | |
| | Film | Acetic | Acid solution | | acid solution | |
| | Thickness | acid | 10 Days | | 10 Days | |
| Example | MSI | Blister | Blush | Blister | Blush | Blister |
| Comparative | 2.38 | 5 | 7 | 4 | 7 | 5 |
| Example 3 | | | | | | |
| Example 7 | 2.00 | 4 | 7 | 4 | 8 | 5 |
| Example 8 | 2.10 | 4 | 8 | 4 | 8 | 5 |

In addition to the results provided above in Tables 20 and 21, it is also expected that coating compositions 7 and 8 would provide improved heat aging performance with improved stability and storage performance over a prolonged period of time, such as over several months, compared to the composition of comparative example 3.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The disclosure is not restricted to the details of the foregoing embodiment(s). The disclosure extends to any novel one, or any novel combination, of the features disclosed in this specification (including any accompanying claims, abstract and drawings), or to any novel one, or any novel combination, of the steps of any method or process so disclosed.

1-77. (canceled)

78. A (co)polymer(A)-acrylic block copolymer obtainable by reacting reactants comprising an acrylic material with a (co)polymer(A), wherein (co)polymer(A) comprises a substantially terminal ethylenically unsaturated functional group, wherein the acrylic material is reacted with (co)polymer(A) so that the acrylic material bonds to (co)polymer(A) via the substantially terminal ethylenically unsaturated functional group.

79. The block copolymer according to claim 78, wherein (co)polymer(A) is obtainable by reacting a (co)polymer(A)-precursor comprising a substantially terminal hydroxyl functional group with a material comprising an ethylenically unsaturated group or precursor thereof.

80. The block copolymer according to claim 78, wherein (co)polymer(A) is obtainable by reacting a (co)polymer(A)-precursor comprising a substantially terminal carboxylic acid-group with a material comprising an ethylenically unsaturated group or precursor thereof.

81. The block copolymer according to claim 79, wherein the material comprising an ethylenically unsaturated group or precursor thereof comprises an anhydride monomer, a vinyl monomer and/or an acrylic monomer.

82. The block copolymer according to claim 79, wherein the material comprising an ethylenically unsaturated group or precursor thereof comprises (meth)acrylic acid anhydride, tetrahydrophthalic anhydride, dodecenyl succinic anhydride, and/or maleic anhydride.

83. The block copolymer according to claim 80, wherein the material comprising an ethylenically unsaturated group or precursor thereof comprises an epoxy functional acrylic monomer and/or a hydroxyl functional acrylic monomer.

84. The block copolymer according to claim 78, wherein the (co)polymer(A) comprises a polyester (co)polymer.

85. The block copolymer according to claim 78, wherein the (co)polymer(A) has an AV of up to 1 mg KOH/g.

86. The block copolymer according to claim 78, wherein the (co)polymer(A)-acrylic block copolymer has an AV of at least 5 KOH/g.

87. The block copolymer according to claim 78, wherein the (co)polymer(A) is obtainable by reacting a (co)polymer(A)-precursor comprising a substantially terminal hydroxyl functional group with a material comprising an ethylenically unsaturated group or precursor thereof and with a material operable to reduce the acid value of the (co)polymer(A).

88. The block copolymer according to claim 78, wherein the acrylic material comprises methyl (meth)acrylate, ethyl (meth)acrylate, hydroxyethyl (meth)acrylate, (meth)acrylic acid, and/or HEMA phosphate.

89. The block copolymer according to claim 78, wherein the acrylic material comprises styrene and/or an acrylamide monomer of formula I, 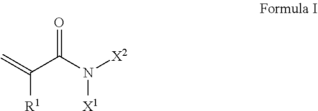
wherein R¹ represents a H or alkyl group; and
X¹ represents a linear or branched alkyl, a —Y—O—Z group; or is according to formula II; 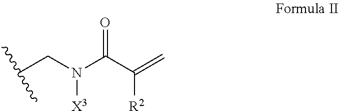
wherein
Y represents a bivalent linear or branched alkylene bridging group, and
Z represents linear or branched alkyl group, or is according to formula II, or H;
X³ represents a H or alkyl group;
R² represents a H or alkyl group;
X² represents a linear or branched alkyl, H or a —Y—O—Z group;
wherein
Y represents a bivalent linear or branched alkylene bridging group, and Z represents a linear or branched alkyl group, or H.

90. The block copolymer according to claim 78, wherein the acrylic material comprises an acid functional monomer in an amount of ≥5% by solid weight of the acrylic material.

91. The block copolymer according to claim 78, wherein the (co)polymer(A)-acrylic block copolymer comprises ≤30 wt % of acrylic material by total solid weight of the (co)polymer(A)-acrylic block copolymer.

92. The coating composition comprising a (co)polymer(A)-acrylic block copolymer according to claim 78.

93. The coating composition according to claim 92, the coating composition further comprising a crosslinking material.

94. The coating composition according to claim 93, wherein the crosslinking material comprises benzoguanamine or a derivative thereof.

95. The coating composition according to claim 93, wherein the crosslinking material comprises a benzoguanamine or a derivative thereof, and a phenolic crosslinker.

96. An article coated on at least a portion thereof with a coating, wherein the article is packaging, a package, a vehicle or a structure, and the coating being derived from a coating composition according to claim 92.
